(19) United States
(12) Patent Application Publication
(10) Pub. No.: US 2005/0075931 A1
(43) Pub. Date: Apr. 7, 2005

(54) Systems and methods for consumers to purchase health care and related products

(76) Inventor: Mark Pearson, Los Gatos, CA (US)

Correspondence Address: HELLER EHRMAN WHITE & MCAULIFFE LLP, 275 MIDDLEFIELD ROAD, MENLO PARK, CA, 94025-3506, US

(21) Appl. No.: 10/931,792

(22) Filed: Aug. 31, 2004

Related U.S. Application Data
(63) Continuation-in-part of application No. 10/669,132, filed on Sep. 22, 2003.
(63) Continuation-in-part of application No. 10/668,689, filed on Sep. 22, 2003.
(60) Provisional application No. 60/530,830, filed on Dec. 17, 2003.

(51) Int. Cl. G06F 17/60; H04M 15/00

(52) U.S. Cl. 705/14; 705/2

(57) ABSTRACT

A method of purchasing products and services utilizes a service provider system. The service provider system offers products for sale through the service provider system directly, and also through associated merchants that are authorized to be associated with the service provider system. Members are enrolled in the service provider system. Points are awarded to members for purchases of products through the service provider system and the associated merchants. Points utilized by members, through the service provider system or associated merchants, are tax free for federal income tax purposes when the points are applied for, (i) health related products and services, (ii) payment of health insurance premiums, (iii) deposit into a Health Savings Account or a similarly approved account, and purchase of a (iv)health care plan.

### CROSS-REFERENCE TO RELATED APPLICATION

This applications is a continuation in part of U.S. Ser. No. 10/669,132 filed Sep. 21, 2003, and U.S. Ser. No. 10/668,689 filed Sep. 22, 2003, and also claims the benefit of U.S. Ser. No. 60/530,830 filed Dec. 17, 2003, which applications are fully incorporated herein by reference.

### FIELD OF THE INVENTION

The present invention is directed to methods and systems using a direct marketing community of members to purchase products and services, and more particularly to methods and systems that use a direct marketing community of members who receive points, rather than income, utilized to purchase products and services.

### DESCRIPTION OF THE RELATED ART

There are currently 240.9 million Americans in the United States who have health insurance, and more than 43.6 million Americans are uninsured. Most of the 43.6 million are young, working class and are not aware they are billed more by physicians and hospitals than insurance companies are for the same service. People who earn modest salaries cannot afford private coverage, and they typically earn too much to be covered by public programs such as Medicaid.

By way of example, consider the case of Mrs. Nix who is 25 years old, uninsured, and has spent nearly $19,200 in medical bills for an appendectomy. New York Methodist Hospital, typically charges HMO's about $2,500 for an appendectomy, which is typically a two day stay in the hospital.

The following table illustrates the percentage of the uninsured population in the United States, by age, in 2001.

| AGES | |
|---|---|
| Under 19 | 23% |
| 19-24 | 17% |
| 25-34 | 22% |
| 35-44 | 17% |
| 45-54 | 13% |
| 55-64 | 8% |

In 2002, only 62% of businesses that employ 10-49 people offered a health plan. In 2001, the number was 66%. Approximately 60% of the 43 million Americans who lack medical insurance are members of families that either own or work for small businesses. Small companies that sign with a new insurance carrier undergo extensive healthcare underwriting and pay more in premiums than larger companies. Additionally, the average health insurance premiums rose 14.8% to $4,564 per employee in 2002.

In 1986, the Consolidation Omnibus Reconciliation Act (COBRA) was enacted and mandated that terminated employees are allowed to purchase health insurance from their former employer for up to 18 months after termination. However, the cost of the continued insurance benefits is fairly high, and few terminated employees can afford the insurance, especially without the income tax advantages of employer paid insurance. Only 21% elect to purchase COBRA

From 1965-2002 the costs of health care costs grew from 5% to 14.7% of GDP. It is estimated that lifestyle behaviors alone contribute to 50% of an individual's health status. Today, there are less employers that offer insurance, and for those that do provide health insurance the costs to the employees have increased. As a consequence, consumers are taking more of the financial risks associated with health care.

It is anticipated that in ten years, employers will be paying a smaller share of overall health care costs and employees will be paying more. In 2002 PPO enrollment jumped to 52% of all covered workers up from 28% in 1996, and enrollment in HMOs fell to 26% from 31% in 1996. The White House proposed spending $89 billion in new tax credits over 10 years to help low income people buy health coverage, congress has set aside $50 billion in its budget. The health savings account, hereafter a “Health Savings Account”, was incorporated and made a part of the Medicaid Prescription Drug Improvement and Modernization Act of 2003, signed by President Bush in December 2003. Direct selling/network marketing organizations market and sell products or services by independent salespeople (person-to-person). More than 43 million people participate in direct selling worldwide. 83% of all direct sellers operate their businesses part-time. Direct selling/network marketing is a rapidly growing industry with U.S. sales of $26.69 billion in 2001. The percentage of American adults who are interested in using the internet as a method of purchasing products and services has increased from 30% of American adults reported in 1997 to 50%. However, direct selling/network marketing organizations have been used by people to make business, resulting in federal income tax consequences. In these instances, people have not referred friends and others to direct selling/network marketing organizations on a limited basis to earn tax free points.

There is a need for methods and systems using a direct marketing community for purchases with an ability to refer third parties on a limited basis to earn tax free points applied to future purchases. There is another need for improved methods and systems that provide for consumer driven health plans, while keeping the costs down on health care. There is a further need for improved methods and systems for providing health care that shift financial incentives from insurance carriers and employers to employees.

### SUMMARY OF THE INVENTION

Accordingly, an object of the present invention is to provide methods and systems for using a direct marketing community for purchases of products and services, with the granting of tax free points that are applied for future purchases.

Another object of the present invention is to provide methods and systems for purchasing products and services through a service provider system and associated merchants where the annual amount of points awarded to an individual member, that are non-taxable for federal income tax purposes, is limited to an annual amount of actual purchases made by the individual member through the service provider system or associated merchants.

Yet another object of the present invention is to provide methods and systems for purchasing products and services through a service provider system, and associated merchants, that award rebate points, with the rebate points being directly related and limited by the amount of purchases made by a member who is awarded the points.

A further object of the present invention is to provide methods and systems for purchasing products and services through a service provider system, and associated merchants, that award rebate points, where the rebate points are used as an offset against the purchase price of future products and services purchased by the member originally awarded the points.

Another object of the present invention is to provide methods and systems for purchasing products and services through a service provider system, and associated merchants, that award rebate points, where the rebate points are used for purchase price adjustments through the service provider or associated merchants.

Yet another object of the present invention is to provide methods and systems for purchasing products and services through a service provider system, and associated merchants, that award rebate points, where the rebate points are rebates that are tied to the purchase of goods or services.

Still another object of the present invention is to provide methods and systems for purchasing products and services through a service provider system, and associated merchants, that award rebate points, where the rebate points represent an adjustment to purchase price rather than as gross income under Section 61 of the Internal Revenue Code.

Another object of the present invention is to provide methods and systems for purchasing products and services through a service provider system, and associated merchants, that award rebate points, where the service provider system is not required to make information reporting under Section 6041A of the Internal Revenue Code for awarding the points.

These and other objects of the present invention are achieved in a method of purchasing products and services. A service provider system is provided. The service provider system offers products for sale through the service provider system directly, and also through associated merchants that are authorized to be associated with the service provider system. Purchases made through the associated merchant are via the internet, or equivalent, or through an associated merchant's brick and mortar store. Members are enrolled in the service provider system. Points are awarded to members for purchases of products through the service provider system and the associated merchants. Points utilized by members, through the service provider system or associated merchants, are tax free for federal income tax purposes when the points are applied for, (i) health related products and services, (ii) payment of health insurance premiums, (iii) deposit into a Health Savings Account or a similarly approved account, and (iv) purchase of a health care plan.

In another embodiment of the present invention, a method of purchasing products and services provided by a service provider system. The service provider system offers products for sale through the service provider system directly, and also through associated merchants that are authorized to be associated with the service provider system. Purchases made through the associated merchant are via the internet, or equivalent, or through an associated merchant's brick and mortar store. Members are enrolled in the service provider system. Points are awarded to a member for purchases made through the service provider system or associated merchants that are, (i) made by the member itself, (ii) made by members who were referred to the service provider system by the member, and (iii) made by members who were referred to the service provider system by members in (ii). Members in (i), (ii) and (iii) are collectively referred to as a member's community. Points utilized by members, through the service provider system or associated merchants, are tax free for federal income tax purposes when the points are applied for, (i) health related products and services, (ii) payment of health insurance premiums, (iii) deposit into a Health Savings Account or a similarly approved account, and (iv) purchase of a health care plan.

In another embodiment of the present invention, a method is provided for purchasing products and services. A service provider system is provided. The service provider system offers products for sale through the service provider system directly and also through associated merchants that are authorized to be associated with the service provider system. Purchases made through the associated merchants are via the internet, or equivalent, or through an associated merchant's brick and mortar store. Members are enrolled in the service provider system. Members are provided with service provider debit or credit cards. Points are awarded to a member for purchases made through the service provider system or associated merchants that are, (i) made by the member itself, (ii) made by members who were referred to the service provider system by the member, and (iii) made by members who were referred to the service provider system by members in (ii). Members in (i), (ii) and (iii) are collectively a member's community. Points utilized by members, through the service provider system or associated merchants, are tax free for federal income tax purposes when the points are applied for, (i) health related products and services, (ii) payment of health insurance premiums, (iii) deposit into a Health Savings Account or a similarly approved account, and (iv) purchase of a health care plan.

In another embodiment of the present invention, a method of purchasing products and services provides a service provider system. The service provider system offers products for sale through the service provider system directly and also through associated merchants that are authorized to be associated with the service provider system. Members are enrolled in the service provider system. Points are awarded to a member for purchases made through the service provider system or associated merchants that are, (i) made by the member itself, (ii) made by members who were referred to the service provider system by the member, and (iii) made by members who were referred to the service provider system by members in (ii). Members in (i), (ii) and (iii) are collectively a member's community. The points represent an adjustment to purchase price rather than as gross income under Section 61 of the Internal Revenue Code.

In another embodiment of the present invention, a method of purchasing products and services provided by a service provider system. The service provider system offers products for sale through the service provider system directly and also through associated merchants that are authorized to be associated with the service provider system. Members are enrolled in the service provider system. Points are awarded to a member for purchases made through the service provider system or associated merchants that are, (i) made by the member itself, (ii) made by members who were referred to the service provider system by the member, and (iii) made by members who were referred to the service provider system by members in (ii). Members in (i), (ii) and (iii) are collectively a member's community. The points are rebate points that are directly related and limited by the amount of purchases made by a member awarded the points.

In another embodiment of the present invention, a method of purchasing products and services provided by a service provider system. The service provider system offers products for sale through the service provider system directly and also through associated merchants that are authorized to be associated with the service provider system. Members are enrolled in the service provider system. Points are awarded to a member for purchases made through the service provider system or associated merchants that are, (i) made by the member itself, (ii) made by members who were referred to the service provider system by the member, and (iii) made by members who were referred to the service provider system by members in (ii). Members in (i), (ii) and (iii) are collectively a member's community. Points awarded by the service provider system and associated merchants are used as an offset against the purchase price of future products and services purchased by the member originally awarded the points.

In another embodiment of the present invention, a method of purchasing products and services provided by a service provider system. The service provider system offers products for sale through the service provider system directly and also through associated merchants that are authorized to be associated with the service provider system. Members are enrolled in the service provider system. Points are awarded to a member for purchases made through the service provider system or associated merchants that are, (i) made by the member itself, (ii) made by members who were referred to the service provider system by the member, and (iii) made by members who were referred to the service provider system by members in (ii). Members in (i), (ii) and (iii) are collectively a member's community. The points are used for purchase price adjustments through the service provider or associated merchants.

In another embodiment of the present invention, a method of purchasing products and services provided by a service provider system. The service provider system offers products for sale through the service provider system directly and also through associated merchants that are authorized to be associated with the service provider system. Members are enrolled in the service provider system. Points are awarded to a member for purchases made through the service provider system or associated merchants that are, (i) made by the member itself, (ii) made by members who were referred to the service provider system by the member, and (iii) made by members who were referred to the service provider system by members in (ii). Members in (i), (ii) and (iii) are collectively a member's community. The service provider system is not required to make information reporting under section 6041A of the Internal Revenue Code for awarding the points.

In another embodiment of the present invention, a method of purchasing products and services provides a service provider system. The service provider system offers products for sale through the service provider system directly and also through associated merchants that are authorized to be associated With the service provider system. Members are enrolled in the service provider system. Points are awarded to a member for purchases made through the service provider system and associated merchants that are, (i) made by the member itself, (ii) made by members who were referred to the service provider system by the member, and (iii) made by members who were referred to the service provider system by members in (ii). Members in (i), (ii) and (iii) are collectively a member's community. Points are awarded to members for purchases made with a credit card issued by a merchant, irrespective if the merchant is an associated merchant, that are, (i) made by the member itself, (ii) made by members who were referred to the service provider system by the member, and (iii) made by members who were referred to the service provider system by members in (ii). The awarded points are used as an offset against the purchase price of future products and services purchased through the service provider system or an associated merchant.

In another embodiment of the present invention, a method of purchasing products and services provides a service provider system. The service provider system offers products for sale through the service provider system directly and also through associated merchants that are authorized to be associated with the service provider system. Members are enrolled in the service provider system. Points are awarded to a member for purchases made through the service provider system or associated merchants that are, (i) made by the member itself, (ii) made by members who were referred to the service provider system by the member, and (iii) made by members who were referred to the service provider system by members in (ii). Members in (i), (ii) and (iii) are collectively a member's community. Points are awarded to members for purchases made with a credit card issued by a merchant, irrespective if the merchant is an associated merchant, that are, (i) made by the member itself, (ii) made by members who were referred to the service provider system by the member, and (iii) made by members who were referred to the service provider system by members in (ii). The points are used for purchase price adjustments through the service provider or associated merchants.

In another embodiment of the present invention, a method of purchasing products and services provides a service provider system. The service provider system offers products for sale through the service provider system directly and also through associated merchants that are authorized to be associated with the service provider system. Members are enrolled in the service provider system. Points are awarded to a member for purchases made through the service provider system or associated merchants that are, (i) made by the member itself, (ii) made by members who were referred to the service provider system by the member, and (iii) made by members who were referred to the service provider system by members in (ii). Members in (i), (ii) and (iii) are collectively a member's community. Points are awarded to members for purchases made with a credit card issued by a merchant, irrespective if the merchant is an associated merchant, that are, (i) made by the member itself, (ii) made by members who were referred to the service provider system by the member, and (iii) made by members who were referred to the service provider system by members in (ii). The points are rebate points that are directly related and limited by the amount of purchases made by a member awarded the points.

In another embodiment of the present invention, a method of purchasing products and services provides a service provider system. The service provider system offers products for sale through the service provider system directly and also through associated merchants that are authorized to be associated with the service provider system. Members are enrolled in the service provider system. Points are awarded to a member for purchases made through the service provider system or associated merchants that are, (i) made by the member itself, (ii) made by members who were referred to the service provider system by the member, and (iii) made by members who were referred to the service provider system by members in (ii). Members in (i), (ii) and (iii) are collectively a member's community. Points are awarded to members for purchases made with a credit card issued by a merchant, irrespective if the merchant is an associated merchant, that are, (i) made by the member itself, (ii) made by members who were referred to the service provider system by the member, and (iii) made by members who were referred to the service provider system by members in (ii);. The service provider pays to the federal government any federal income tax due that results from awarding the points.

In another embodiment of the present invention, a method of purchasing products and services provides a service provider system. The service provider system offers products, for sale through the service provider system directly and also through associated merchants that are authorized to be associated with the service provider system. Members are enrolled in the service provider system. Points are awarded to a member for purchases made through the service provider system or associated merchants that are, (i) made by the member itself, (ii) made by members who were referred to the service provider system by the member, and (iii) made by members who were referred to the service provider system by members in (ii). Members in (i), (ii) and (iii) are collectively a member's community. The service provider pays to the federal government any federal income tax due that results from awarding the points.

### BRIEF DESCRIPTION OF THE DRAWINGS

FIG. 1(a) is a block diagram illustrating one embodiment of a service provider system of the present invention.

FIG. 1(b) is similar to FIG. 1(a) but adds additional details for one embodiment of a service provider system of the present invention.

FIG. 2 is a block diagram that illustrates one embodiment of member aggregation used with a service provider system of the present invention.

FIG. 3 illustrates how new members enter the service provider system in one embodiment of the present invention.

FIG. 4 illustrates one embodiment of a membership tree utilized in an embodiment of a service provider system of the present invention.

FIG. 5 is a diagram that illustrates one embodiment of a service provider system of the present invention with member down-line and up-line groups.

FIG. 6 is a diagram for one embodiment of service provider system of the present invention illustrating how purchases by a member benefits members one and two levels up-line.

FIG. 7 is a diagram for one embodiment of service provider system of the present invention illustrating up-line flows for multiple levels.

FIG. 8 is a diagram for one embodiment of service provider system of the present invention illustrating up-line flows only for a member on tier N.

FIG. 9 is a diagram for one embodiment of service provider system of the present invention illustrating the amplification effect, referral quota equal and a referral length.

FIG. 10 is a diagram for one embodiment of service provider system of the present invention illustrating how the status of a vendor effects point aggregation.

FIG. 11 is a diagram for one embodiment of service provider system of the present invention illustrating how that point awarding can be event driven by the processing of financial institution transaction records.

FIG. 12 is a diagram for one embodiment of service provider system of the present invention illustrating a distribution of a member's point after the member has exceeded its point cap.

FIG. 13 is a diagram for one embodiment of service provider system of the present invention illustrating a redeemable point cap.

FIG. 14 is a diagram for one embodiment of service provider system of the present invention illustrating that expired points can be created to negate the efficacy of the awarded points.

FIG. 15 is a diagram for one embodiment of service provider system of the present invention illustrating the flow of consideration through service provider system.

FIG. 16 is a diagram for one embodiment of service provider system of the present invention illustrating a member requesting a credit card from service provider system.

FIG. 17 is a diagram for one embodiment of the present invention illustrating one relationship between a member and the bank account and trust account of the service provider system.

FIG. 18 is a diagram for another embodiment of the present invention illustrating one relationship between a member and the bank account and trust account of the service provider system.

FIG. 19 is a diagram for another embodiment of the present invention illustrating one relationship between a member and the bank account and trust account of the service provider system.

### DETAILED DESCRIPTION OF THE PREFERRED EMBODIMENTS

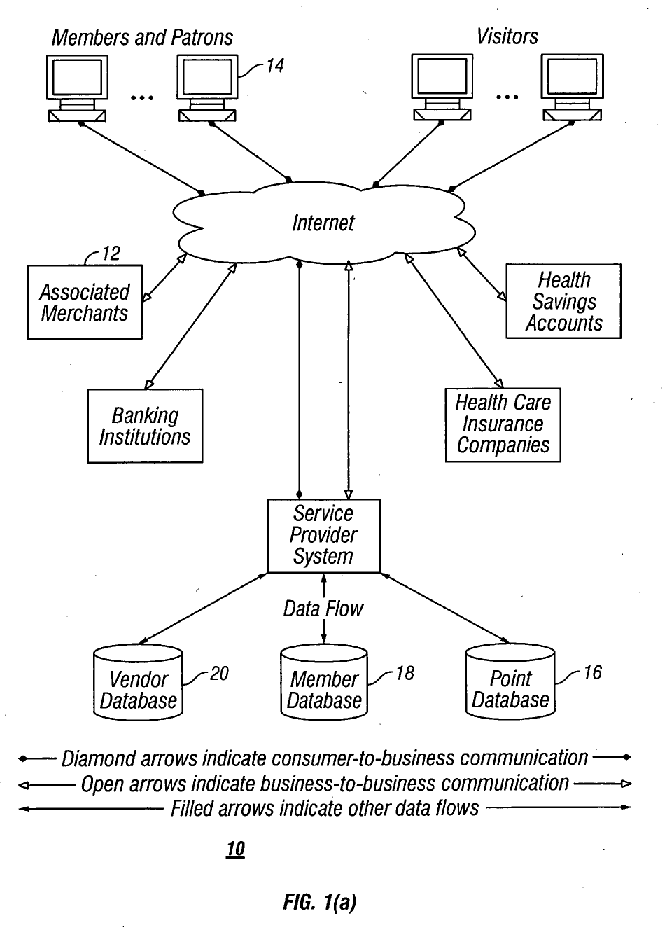

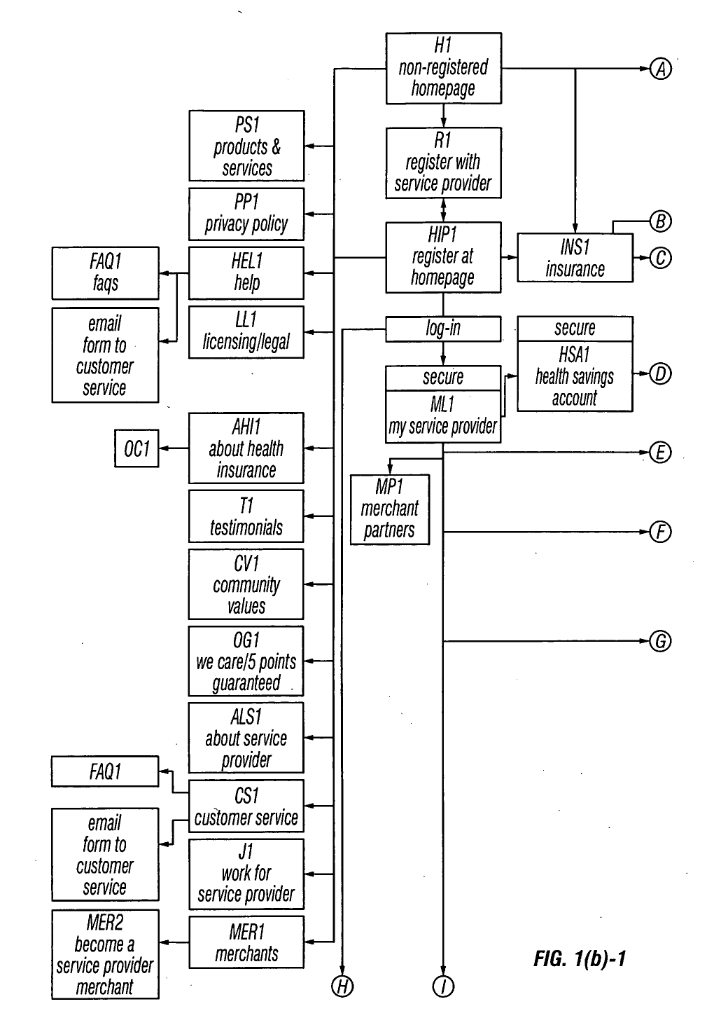

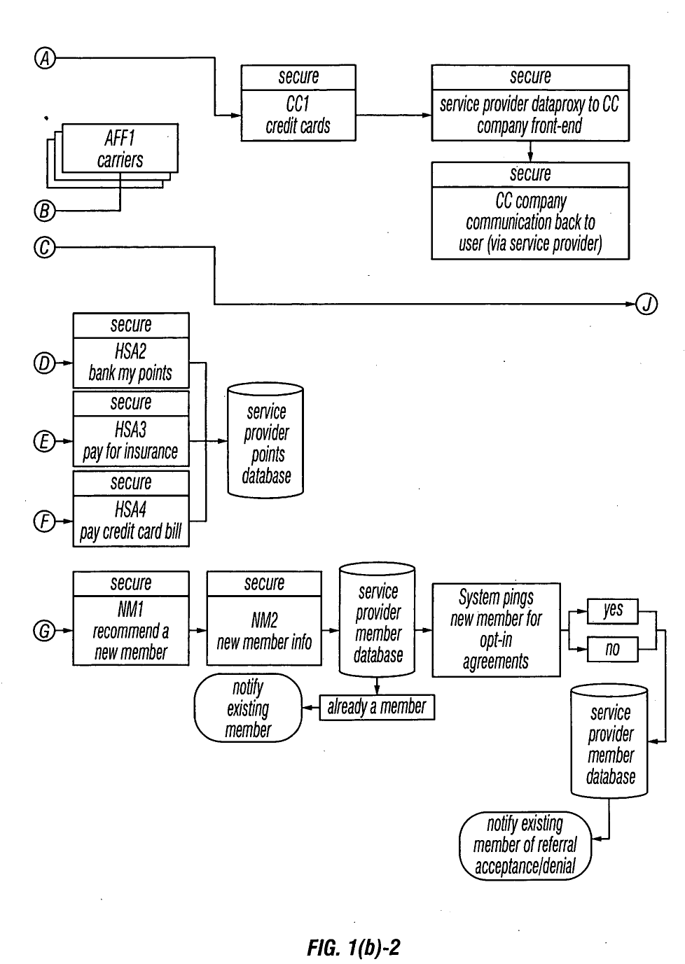

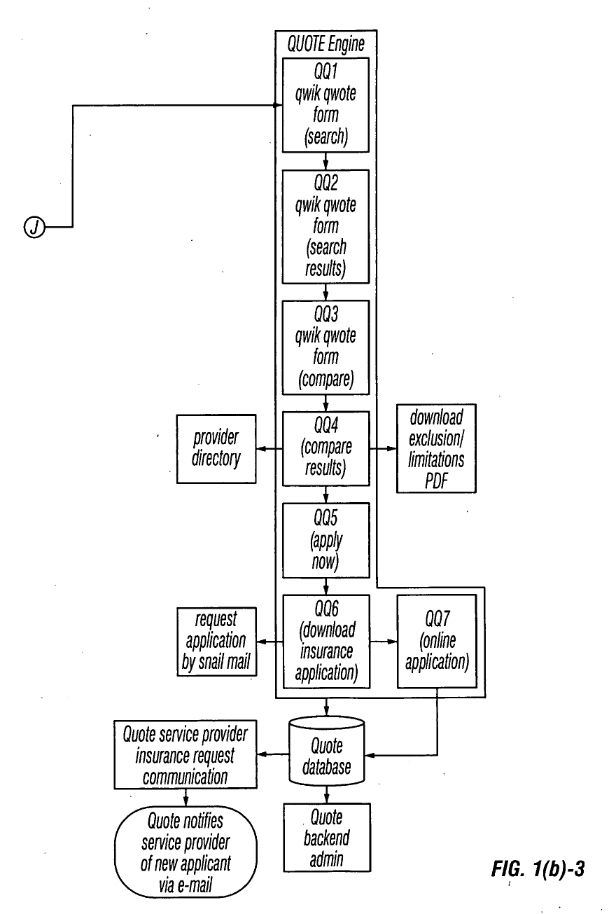

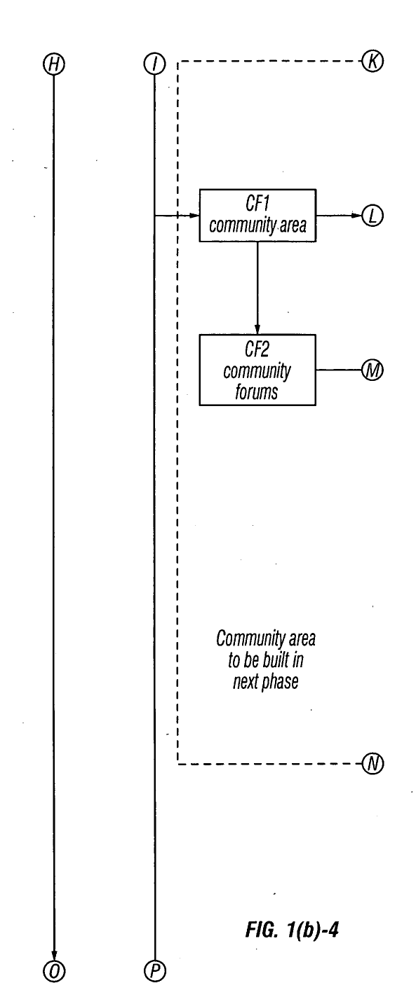

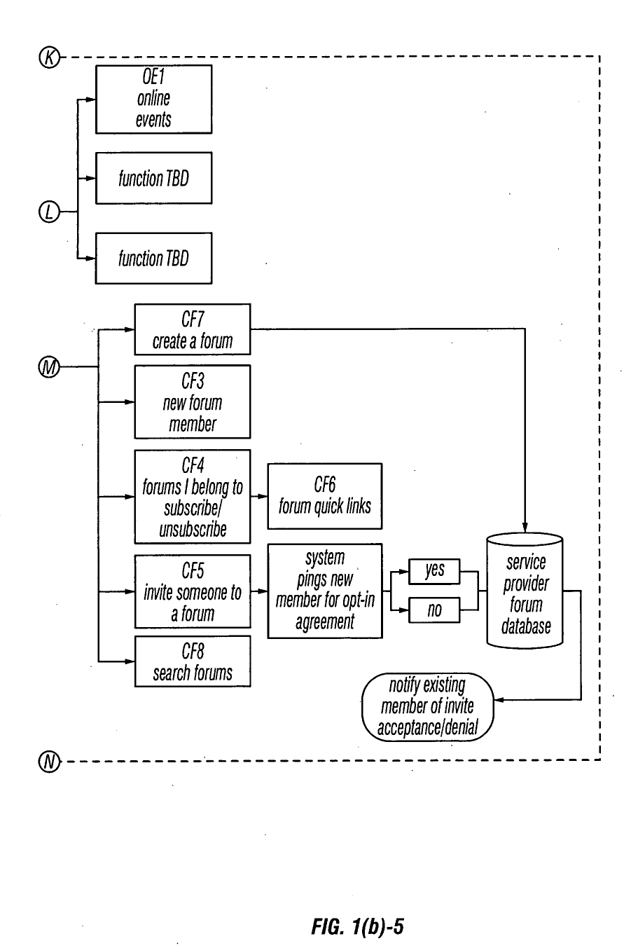

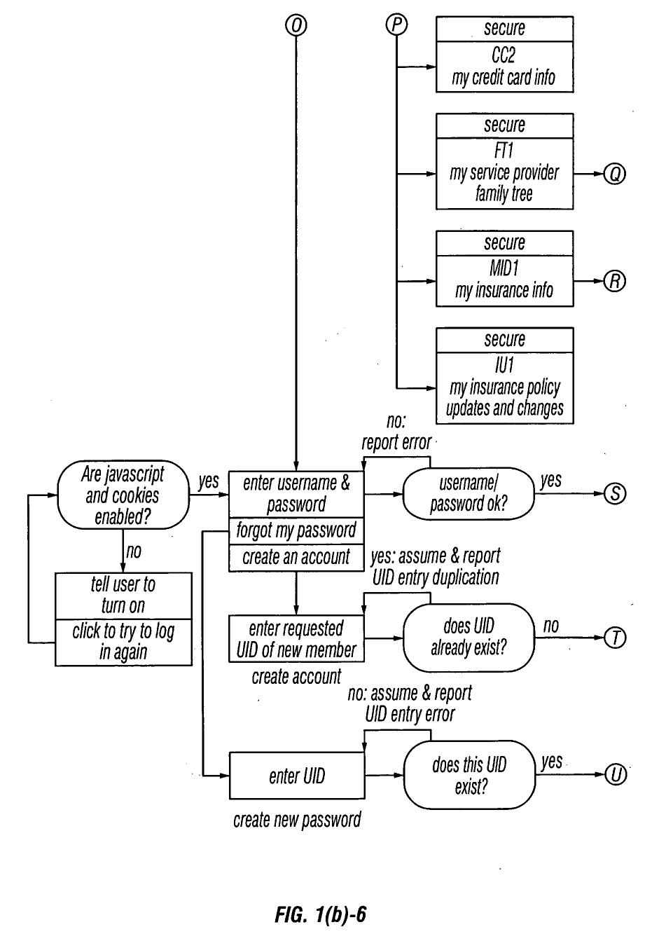

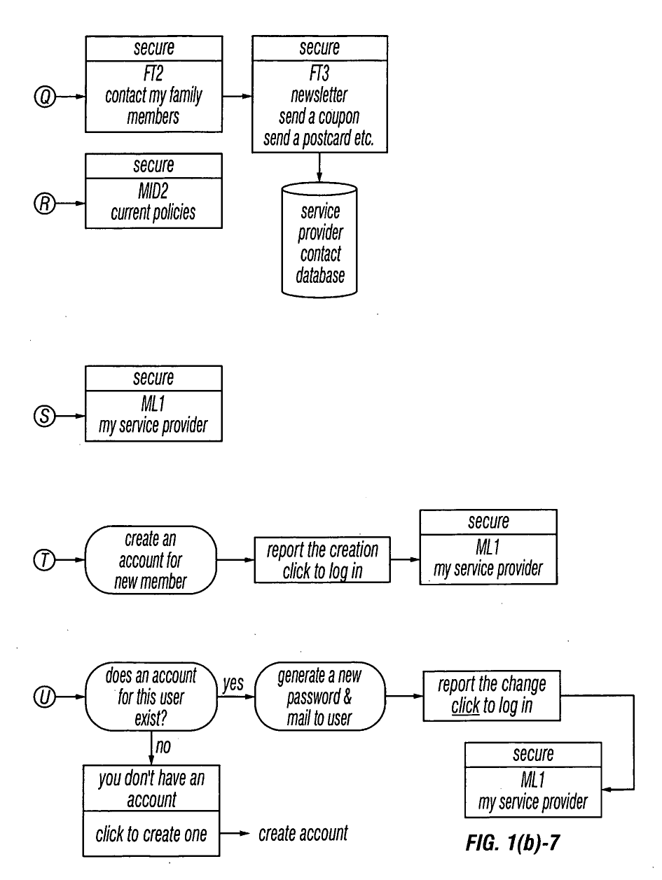

In one embodiment of the present invention, illustrated generally in FIGS. 1(a) and 1(b), a service provider system 10 has one or more web servers 12. Service provider system 10 enrolls prospective members as members, collectively members 14. Service provider system 10 offers products and services for sale through service provider system 10 directly, and also through associated merchants, generally denoted as 12, that are authorized to be associated with service provider system 10. Purchases made through the associated merchant 12 are via the internet, or equivalent, or by a merchant's brick and mortar store.

Points are awarded to members 14 for purchases of products through service provider system 10 and associated merchants. Members 14 may redeem previously awarded points at the time of a new purchase to offset part or all of the cost of the new purchase. In one embodiment, one point is the equivalent of one dollar, and fractions of points/dollars are kept by service provider system to four decimal places. Points can only be used to offset the retail total of an invoice and cannot offset tax or shipping charges. Points can also be used to offset part or all of the cost of a member service, including but not limited to health insurance, and the like.

Points utilized by members 14, through service provider system 10 or associated merchants, can be tax free for federal income tax purposes. In one specific embodiment, the points are applied for, (i) health related products and services, (ii) payment of health insurance premiums, (iii) deposit into a Health Savings Account or a similarly approved account, and (iv) purchase of a health care plan. In one embodiment, if a portion or all of the awarded points are treatable as taxable income for federal income tax purposes, service provider system 10 can pay the tax directly, and make it seamless to members 14.

In one embodiment, the health care plan and/or the health insurance premiums can be at least partially funded by an employer's contributions, and points can be used by the employee, if the employee is a member, through service provider system 10 to offset the employee's costs. At least a portion of the costs of a member's 10 health care insurance plan or other health-related insurance can be payable with points awarded by service provider system 10 and associated merchants 12 to a member 14 for purchases made by that member 14 through service provider system 10.

For purposes of tax free status, points are rebate points that are directly related and limited by the amount of purchases made by a member 14 being awarded the points. Points awarded by service provider system 10 and associated merchants 12 are used as an offset against the purchase price of future products and services purchased by the member 14 originally awarded the points. The points are used for purchase price adjustments in a manner consistent with well established rules. The points can be considered as rebates that are directly tied to the purchase of goods or services and represent an adjustment to purchase price rather than as gross income under Section 61 of the Internal Revenue Code. Service provider system 10 is not required to make information reporting under Section 6041A of the Internal Revenue Code with respect to the awarding of volume based purchase discount/rebate points.

For the purposes of tax free status, points awarded by service provider system 10 and associated merchants 12 are volume based and are designed to encourage members 14 that are neither employees of, nor provide services to, to use service provider system 10 for their healthcare needs. Even where the points result in a 100% reduction in the cost of a product or service, the discount does not constitute gross income under section 61 to the member 14 receiving the award. Members 14 are not employees of service provider system 10 in their role as members 14 purchasing products and services.

Members 14 accrue points each time they purchase a product or service through service provider system 10 or an associated merchant. In one embodiment, points are converted to and from money at the rate of 1 point per $1.00 for purchases of future products and services from service provider system and associated merchants. Service provider system 10 receives a commission on each purchase made through service provider system 10 an associated merchant 12, insurance carrier, financial institution, and other entities associated with service provider system for purchases by members 14. Commission percentages are contained in a database and can be on a per-product basis, on a per vendor bases, and the like. Service provider system 10 supports commission data entry and maintenance.

Points can be applied to a variety of different products and services, including but not limited to, the costs of health care services, insurance and related products, and if not used in that year rolled over to costs for subsequent years. Members 14 can be initially enrolled in heath care plans and other types of health-related insurance plans outside of service provider system 10, and then use their purchases, through service provider system 10 in the form of points, to offset and pay for their associated costs and fees of health care services, health care insurance plans, health related insurance and related products, that are not covered by their employers, and the like.

In one embodiment, service provider system 10 provides a means for members 14 to reduce or eliminate the cost of obtaining high quality medical care and health insurance. This can be achieved by purchasing, for their own use and by leveraging the buying power of family, friends, and associates, products and services provided by third party retailers and service providers.

In one embodiment, points awarded are not only to a member 14 itself for purchases made through the service provider system or associated merchants, but also for those purchases through service provider system and associated merchants that are, (i) made by members 14 who were referred to the service provider system by the member, and (ii) made by members 14 who were referred to the service provider system by members 14 in (i). The original member is known as the “referring member. Members 14 in categories (i) and (ii) are known as the “referring member's community” or the “member's community”. Members 14 in the member's community can also receive points for purchases made with credit cards issued by merchants, even if the merchant is not associated with service provider system 10.

In one embodiment, the number of points that a member can apply to pay for, (i) health related products and services, (ii) health insurance premiums, (iii) deposit into a Health Savings Account or a similarly approved account, and (iv) purchase of a health plan, has an annual cap.

An annual amount of points awarded to an individual member 14, that are non-taxable for federal income tax purposes, is limited to an annual amount of actual purchases made by the individual member 14 through the service provider system or associated merchants. Members 14 are notified of their point balances by service provider system 10 and can be advised that they have unused points, that they need additional points for purchases, and the like. The points awarded are recorded within a computer memory the points awarded to members. Points awarded are utilized by members 14 for future purchases of products or services through service provider system 10 or an associated merchant 12.

The purchasing power of members 14 in service provider system is aggregated to reduce costs of products and services. None of the points can be converted to cash or a cash equivalent if they are utilized outside service provider system 10 or an associated merchant 12. Points that are non-taxable for federal income tax purposes have a limited life, which can be, by way of example, no more than 24 months. Points not used by a member 14 remain within service provider system 10.

Points that exceed a member's cap can be distributed to it's member community, distributed equally to it's member community, non-equally, but in any event stay within service provider system 10, as more fully explained below.

Service provider system 10 and associated merchants can have browsable catalogs of products and services. Purchases can be made directly for any product or service at a storefront of an associated merchant 12. Service provider system 10 can provide members 14 with a credit/debit card, as more fully explained below. The service provider debit or credit card can have an annual fee. In one embodiment, a portion of the points awarded can be utilized for payment of the annual fee of the credit/debit card.

Service provider system 10 includes a point engine. Point engine can include multiple function software and can be a series of methods that are invoked for key events in service provider system 10. Service provider system can include a WEB server where people can learn about service provider system 10 and join service provider system 10, and the service provider community, through web-page interaction. An interface to a financial institution is included for the processing of settlement.

In one embodiment, service provider system 10 patrons and members 14 create financial institution transactions by using a credit/debit card associated with service provider system 10 from an affiliated financial institution. Use of the credit/debit card earns points for members 14 points that accrue and may be redeemed for future purchases, but not for direct cash, and/or applied to the purchase of health insurance and/or inserted as cash into a government sanctioned Health Savings Account, equivalent, and as amended from time to time. Service provider system 10 also provides for the redemption of points, selling of health insurance, and management of Health Savings Accounts,

FIGS. 1(a) and 1(b) illustrate an overview of service provider system 10. Visitors may sign up by means of on-line communication to become patrons or members 14. A point database 16 contains information about each member's point accrual standings as well as various global parameters and conversion constants. Included are a member database 18 and a vendor database 20.

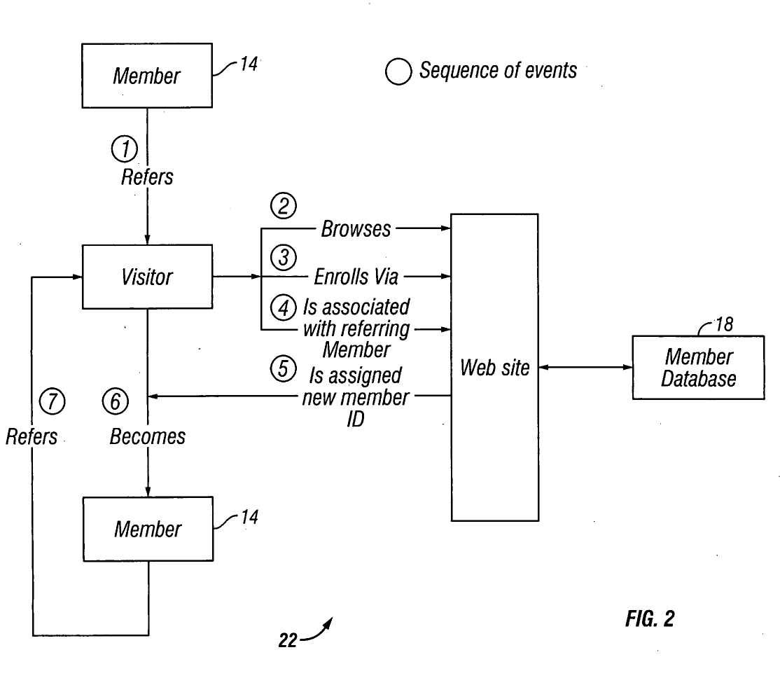

FIG. 2 illustrates one embodiment of member 14 aggregation. There are several methods of becoming a member 14 In one embodiment, a referrer/referee relationship between members 14 requires several algorithms to be implemented.

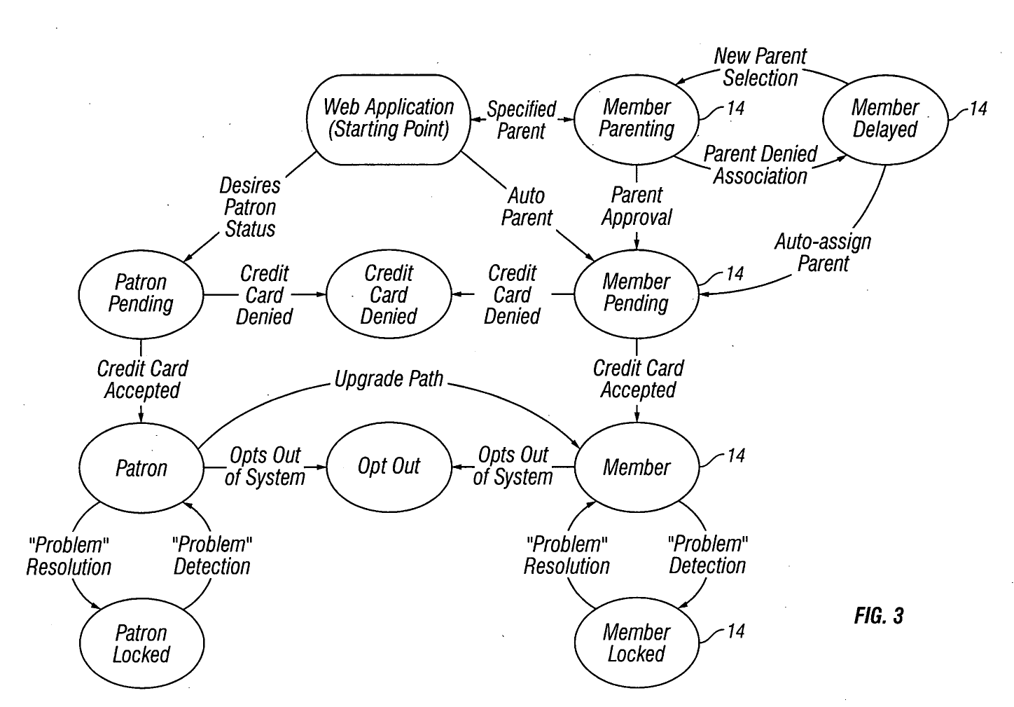

Referring now to FIG. 3, patrons who have not become members 14 may use their credit/debit card and earn any benefits offered by the banking institution. However, as non-members they do not accrue points. Such non-members must still register with service provider system 10 in order to record financial information such as billing address and other personal information. Several levels of status are defined in

TABLE 1
Membership Status

| Membership | |
|---|---|
| Status | Description |
| Visitor | A person visiting the Service Provider System web |
| | site interested in finding out more information about |
| | the Service Provider System Health Network and has |
| | never established a personal database record. There |
| | is no official Visitor status within the database since |
| | by definition a visitor does not have a database |
| | record. |
| Member Delayed | A member was refused a parent association and |
| | needs to try and establish a new referee relationship, |
| | or in the alternative, agree to have Service Provider |
| | System automatically assign the prospective member |
| | a surrogate referee. |
| Member | A person who has established a relationship with |
| Parenting | Service Provider System by establishing a personal |
| | record in the database and has opted to join as a |
| | member and is currently waiting approval by his |
| | referrer to become one of his referrer's referees. |
| Patron Pending | A person who has established a relationship with |
| | Service Provider System by establishing a personal |
| | record in the database and has not opted to join as a |
| | member and has not yet received their credit card. |
| Member Pending | A person who has established a relationship with |
| | Service Provider System by establishing a personal |
| | record in the database and has opted to join as a |
| | member and has not yet received their credit card. |
| Patron | A pending patron becomes a patron once their credit |
| | card has been issued. |
| Member | A pending member becomes a member once their |
| | credit card has been issued. A Service Provider |
| | System Health Network member (through selection |
| | on a registration web page) has an association with |
| | an existing member (and becomes part of the existing |
| | member's down-line.) |
| Opted Out | A person who was once a patron but has opted out of |
| | the Service Provider System system. |
| Credit Card | A person who had his credit card request denied. |
| Denied | Human intervention is required to leave this state. |
| Patron Locked | A person who is currently a patron but for ancillary |
| | reasons is not allowed to have credit card |
| | transactions processed until the account locking |
| | issues are resolved. This state is pretty much bogus |
| | and only comes into play for certain, as yet “to be |
| | determined”, issues involving patrons converting to |
| | members and keeping previously earned points |
| | during their patron status. Currently, the requirement |
| | is for patrons not to accrue earned/awarded points |
| | and for Service Provider System to usurp those |
| | funds. Human intervention is required to leave this |
| | state. |
| Member Locked | A person who is currently a member but for ancillary |
| | reasons is not allowed to have credit card |
| | transactions processed and points accrued until the |
| | account locking issues are resolved. Human |
| | intervention is required to leave this state. |
| Member Root | The root member is a special place-holder (not a real |
| | person) in the membership tree 22. The root member |
| | is the root node of the membership tree 22. There is |
| | only one root member in the system. |
| Error | The database record for the member has been |
| | determined as corrupt and human intervention is |
| | required to leave this state. |

In one embodiment, a member 14 is referred by an existing member 14 and establishes an association. Purchases by the new member 14 benefit the referring member 14 via the accumulation of points. The referring member's 14 referring member 14 also benefits.

Membership and patron identifiers are visible to the “outside world” and are created automatically by service provider system 10. They are unique identifiers. If feasible, the user may be asked to input his social security number and that will be used in place of the auto-generated identifier. Web pages requiring user identification can mandate the inputting of an email-address rather than the unique ID.

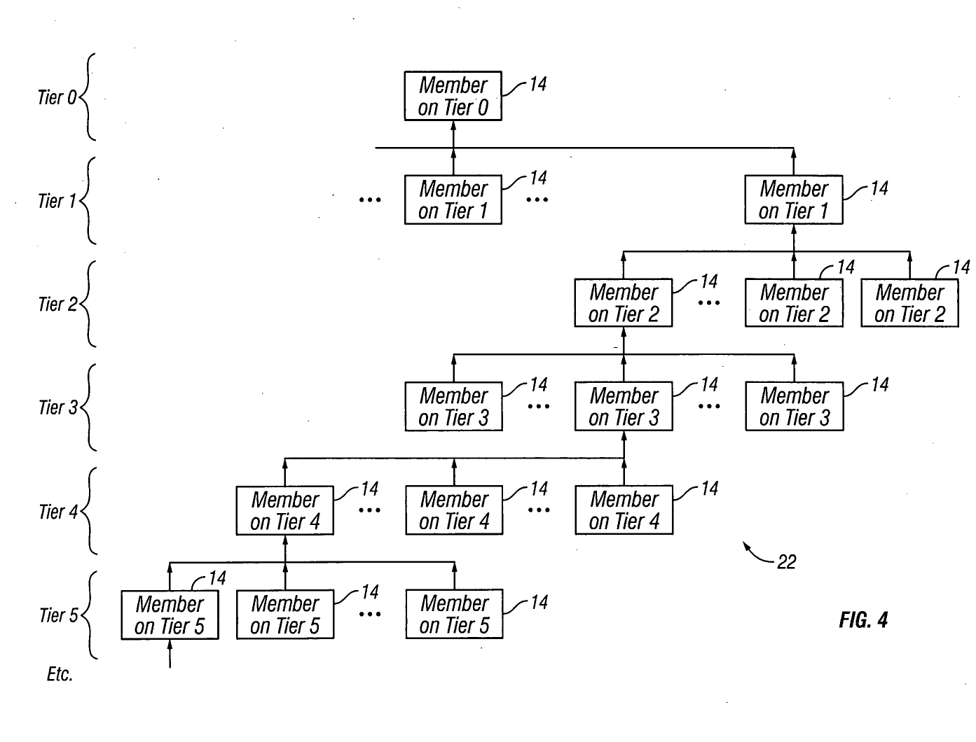

Referring now to FIG. 4, one embodiment of a membership tree 22 is illustrated. Referees become part of a referrer's down-line. Down-line member 14 purchases benefit not only the member 14 making the purchase, but also some of those member 14 above. As members 14 enter service provider system 10, they form an association in the form of a tree structure. Members 14 are inserted into the membership tree, generally denoted as 22 at various tier numbers, and become what is termed as tier members. There is only one member on tier 0, called the root member. When a member 14 leaves service provider system 10, and becomes a non-member, some of membership tree 22 is rearranged and the terminating member's sub-tree is repositioned elsewhere in the global tree structure.

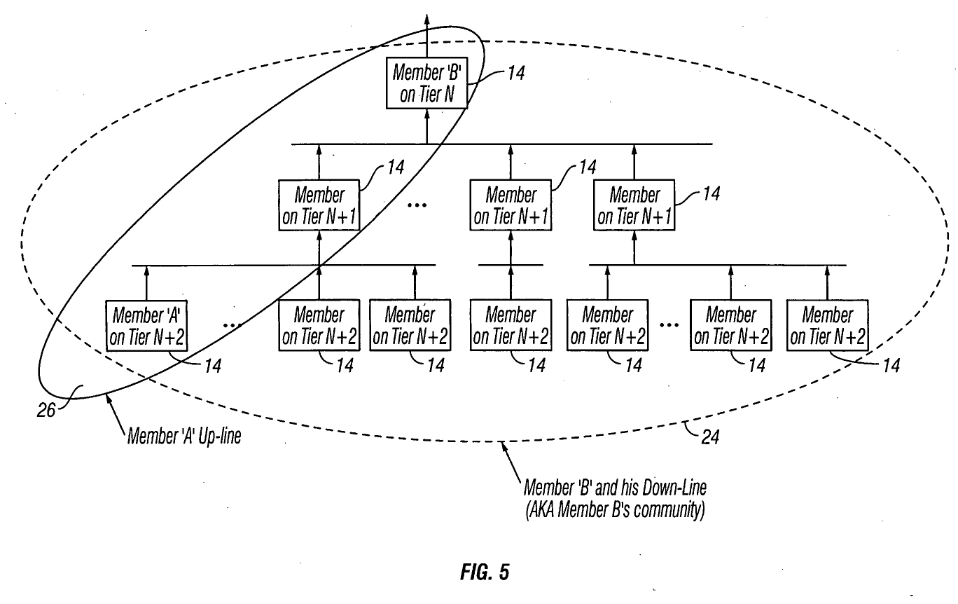

In one embodiment, the number of referees is limited to what is called a referral quota as illustrated in FIG. 5. FIG. 5 shows a members 14 down-line group or flow 24 and up-line group or flow 26. Down-line group 24 is also referred to as member “B's” community. Patrons are inserted into service provider systems member database 18 but do not have a tree association, e.g., a children or parent relationship is not present.

For purposes of this specification, a root member is not a person but an abstraction acting as the root of membership tree 22. Up-line flows 26 directed at the root member, or above, become part of the profits of service provider system 10 Maintaining the root member as an abstraction eliminates difficulties in root member deletion and sub-tree reassignment that would otherwise be necessary considerations. The root member also acts as a member entity to accrue commissions on purchases by members 14 for service provider system 10.

In one embodiment, service provider system 10 has a database tool called the Membership Editor that allows for manual modification of membership down-line relationships to facilitate membership tree 22 maintenance. Access to the tool requires a specific access privilege. In one embodiment, for a visitor to transition to patron or member status, the following information is entered into the service provider system 10.

1. Name.

2. Address.

3. Daytime phone.

4. Evening phone (optional.)

5. Email address (Membership ID.)

6. “Radio” button asking: “I would like to become a member in the Service Provider System Health Network (not necessary to purchase products but no points are awarded to non-members.)”
1 Yes
2 No

7. Referring member's last name (required if line 6 is “yes”.)

8. Referring member's Membership ID (required if line 6 is “yes”.)

9. “Radio” button response selection to: “How did you hear about the Service Provider System Health Network?”
1 Existing member (default.)
2 Newspaper article.
3 Service Provider System mail/email solicitation.
4 Television.
5 Radio.
6 Friend that is not currently a member.
   Table 2—Registration Information

For a visitor or patron to become a member, the same registration web page can be used to uniquely identify and establish an association with a “referring” member 14. Entering the name of the referring member 14 and the service provider system ID can be required.

In one embodiment, the referring member receives an email asking for confirmation of the prospective member's request for association by annunciating the prospective member's name and email address. This can be accomplished through e-mail. The email contains a web site URL that can be selected, starting up the member's browser to a service provider system web page containing relevant information and two radio buttons for approval/disapproval of the prospective member's request.

If the referring member selects approval, the prospective member will become part of the referring member's down-line flow 24 and the prospective member will receive an email confirming his successful membership association. However, at the time of approval, if the referring member's referral quota has been filled, both the referrer and referee will receive notification the association could not be established, and the prospective member will have to be referred by another member, or solicit membership through service provider system 10. If disapproval is selected, the referee will receive a notification indicating the referring member did not approve the association and will have to find another referrer.

Service provider system 10 can provide a web-page-based mechanism that can be used for a prospective member that does not have a friendly association with an existing member 14, and therefore cannot be referred. This provides another method of enrolling. The prospective member may be a visitor or patron. An automated processs, called the solicitation process, can be utilized assign the prospective member to a pseudo-referring member. The solicitation process utilizes a down-line reassignment to locate a suitable member 14 as the referrer and establish the new down-line relationship 24.

In one embodiment, the web page for a membership solicitation can require the following items.

1. Name.

2. Address.

3. Daytime phone.

4. Evening phone (optional.)

5. Email address (membership ID.)

6. “Radio” button response selection to: “How did you hear about the Service Provider System Health Network?”
1 Existing member (default.)
2 Newspaper article.
3 Service Provider System mail/email solicitation.
4 Television.
5 Radio.
6 Friend that is not currently a member.
   Table 3—Solicitations for Membership

Members 14 may terminate their membership status by means of web page access. A terminated member becomes an Ex Member and the corresponding database information about the member remains intact. The terminating member's 14 down-line flow 24 and all lower down-lines (i.e., the terminating member's entire sub-tree) are transferred to an existing member by using down-line reassignment.

Awarded points associated with the member 14 at the time of membership termination are destroyed and the funds representing those points are transferred from the a trust account to a bank account of service provider system 10.

Automated down-line flow 24 reassignments can occur when a member 14 elects out of service provider system 10. Reassignment is accomplished through the down-line reassignment process. When a sub-tree is reassigned, the member 14 receiving the sub-tree will receive notification of the fact a terminating member 14 has triggered a reassignment and he now has some down line members 24 as a consequence.

The down-line flow 24 reassignment process allows members 14 to define their own relationships, whenever possible, and automatically assign members 14 only to other members 14 who have already requested automatic assignment. In this manner, membership tree 22 is partitioned into members 14 that know each other and members 14 who do not care about relationships to acquaintances. Therefore, when automatic assignment is necessary the approach is to locate a member 14 in membership tree 22 that has recently had children assigned, because the member 14 would be a known candidate, and then assign more children to that member 14 or to that members children. If such a candidate cannot be found, the root member can be consulted to see if the root's referral quota has not been filled. If the root member has no available slots for a new sub-tree, e.g., new child, then other members 14 are used for a parent of automatic assignment.

In one embodiment, service provider system utilizes a global mutable database parameter called the referral length that can be used to establishes the fact of a three-tier down-line flow 24. It will be appreciated that service provider system 10 is not limited to three-tiers. The figures and discussion that follow are directed to a three tier embodiment.

When discussing the member association from a referrer's point of view the word down-line is used. However, point aggregations flow upward when a member uses its credit/debit card. When the point of view is from a purchasing member, the term up-line is used.

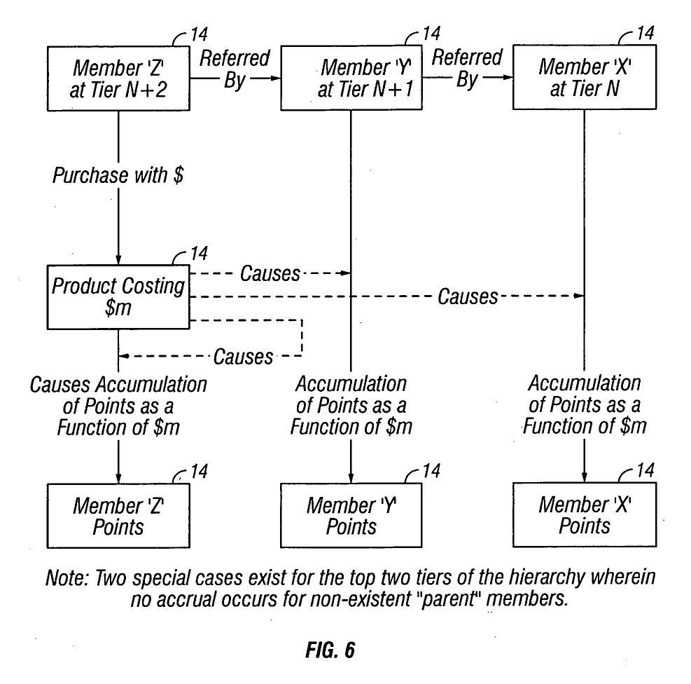

FIG. 6 illustrates how purchases by a member 14 benefit members one and two levels up-line. In FIG. 3, members ‘Y’ and ‘Z’ are part of member ‘X's’ down-line. A purchase by member ‘Z’ causes the accumulation of points, based on the price of items purchased by member Z, for not only himself but members ‘Y’ and ‘X’ as well. The number of points accumulated is based on amounts reported in credit/debit card transactions received from the authorizing bank, as well as for those where a credit/debit card is not utilized..

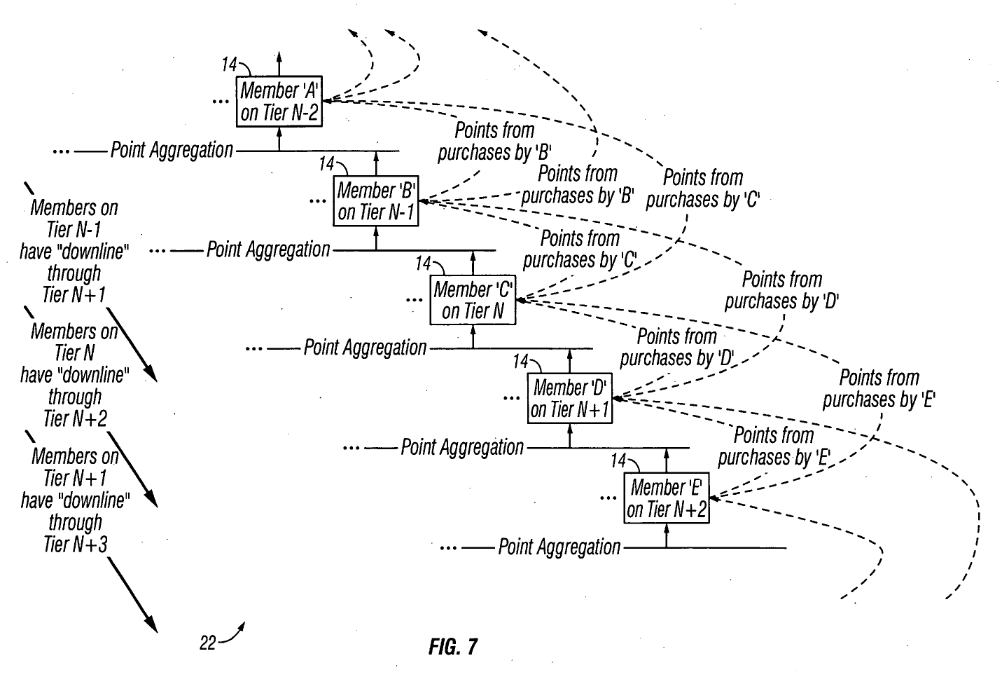

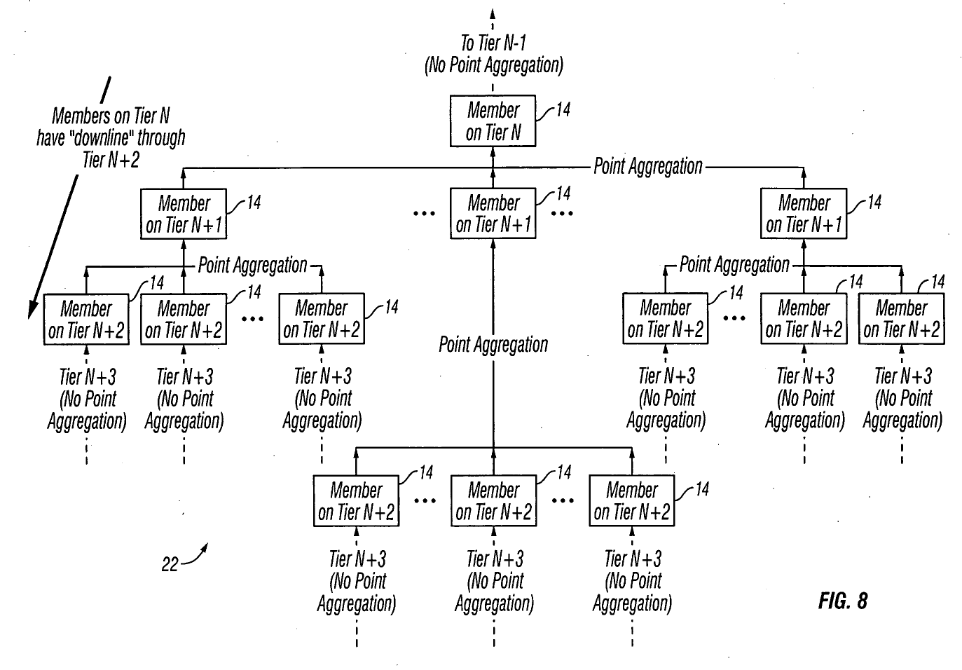

FIG. 7 shows the up-line flows for multiple levels. FIG. 8 further illustrates the up-line flows only for a member on tier N.

### EXAMPLE 1

### Distribution Fractions

The following table is one embodiment of database parameters used with service provider system 10.

Database Parameters

| Symbol | Description | Value (for discussion) |
|---|---|---|
| R_{L} | Referral length - number of tiers in the tree | 3 |
| | structure having money flows when a purchase | |
| | is made. Equivalent to the old down-line | |
| | length. | |
| R_{Q} | Referral quota - the number of members that | 6 |
| | can be referred by, and associated with, any | |
| | member. | |
| D(v, l) | $\begin{matrix}\text{Distribution factors for up-line level I,} l = 0 ⇒ \\ purchasing member , l = 1 ⇒ purchasing \\ \text{member's referrer,} l = 2 ⇒ purchasing \\ \text{member's referrer's referrer, etc.} l > {R}_{L} . The \\ \text{distribution fractions for a given vendor v} \\ \text{MUST total 1.0000.}\end{matrix}$ | $\{ \begin{matrix}D ( v , 0 ) = 0.4706 \\ D ( v , 1 ) = 0.2588 \\ D ( v , 2 ) = 0.2706\end{matrix}$ |
| D_{LS}(v) | Service provider system 10 distribution - the | 0.0250 |
| | fraction of a member's purchase based upon | |
| | vendor v that constitutes service provider | |
| | system 10 profit. | |
| D_{M}(v) | Member distribution - the fraction of a | 0.0850 |
| | member's purchase based upon vendor v that | |
| | is distributed to the member's up-line. Each of | |
| | D(v, l) is multiplied against this value. | |
| D_{C}(v) | Community distribution - the fraction of a | 0.0100 |
| | member's purchase placed into the community | |
| | pool for periodic distribution to community | |
| | members that achieve certain purchase goals. | |
| D_{TOT}(v) | Total purchase distribution. Definition. | ${D}_{TOT} ( v ) = \\ {D}_{LS} ( v ) + {D}_{M} ( v ) + {D}_{C}$ |
| T_{R}(v) | Product return period, in days for vendor v. | 30 Days |
| T_{C} | Community distribution period, in days. | 30 Days |
| P_{C} | Awardable point cap - the maximum number | 10,000.00 |
| | of points a member may earn in a calendar | |
| | year. Points earned above this level are | |
| | distributed to the down-line members. See | |
| | section 0. | |
| P_{M} | Minimum point redemption - the minimum | 10.0000 |
| | number of points a member may redeem at | |
| | any one time. | |

Non-Constant Parameters

| Symbol | Description | Definition |
|---|---|---|
| m | Member identifier. | |
| l | $\begin{matrix}\text{Up-line community level relative to} \\ purchasing member , l = 1 ⇒ purchasing \\ \text{member's tier level,} l = 2 ⇒ up level up , etc .\end{matrix}$ | |
| C_{S,max} | Community size maximum. Equal to 43 with R_{Q} = 6 and R_{L} = 3. | ${\sum }_{i = 0}^{{R}_{L} - 1} {( {R}_{Q} )}^{i}$ |
| C_{S}(m) | Community size of community headed by | Computationally |
| | member m. | determined. |
| C_{P}(m) | Community population fraction of maximum community size | $\frac{{C}_{S} ( m )}{{C}_{S , max}}$ |
| C(m) | List of all members in the community | Computationally |
| | headed by member m. | determined. |
| M(m, l) | Member identifier of referring member to m | Computationally |
| | on up-line level I. M(m, 0) would be m, | |
| | M(m, 1) would be the referring member | |
| | “above” m, M(m, 2) would be the referring | |
| | member's referring member two levels | |
| | above member m. | |
| A(m) | Total dollar purchase sum by member m | Computationally |
| | during current community pool distribution | determined. |
| | period. | |

The distribution fractions are not random numbers but must be chosen to optimize a variety of business and mathematical considerations. The following are required relationships.

$${\sum }_{l = 0}^{{R}_{L} - 1} D ( v , l ) = 1 for any given vendor v . \qquad ( 1 )$$

D_{TOT}(V)=D_{LS}(V)+D_{M}(V)+D_{C}(V) (2)

Service provider system 10 negotiates with in-network vendors in an effort to maximize D_{TOT}(V) Service provider system 10 “divide up the pie” by choosing D_{LS} (v), D_{M} (v), and D_{C}(v). Increasingly difficult considerations are necessary when choosing the up-line percentages. Consider the following equation whose left-hand-side indicates what the top member of an up-line receives if his entire down-line membership purchased the same product, which includes the top up-line member.

$${D}_{M} ( v ) P {\sum }_{l = 0}^{{R}_{L} - 1} D ( v , l ) {( {R}_{Q} )}^{l} ⇔ P \qquad ( 3 )$$

P is the amount of purchase of all down-line members and the symbol [symbol] is a relational separator that is one of “<”, “=”, or “>”. The equation, with “=” (equals), indicates that if every member in a given down-line were to purchase exactly the same amount, the member M(m,R_{L}−1) would recoup all of his expenditures. That member is capped by IRS ruling to the amount P in terms of redeemable points, but not awarded points. As an example and using the values from above:

$$\begin{matrix}{D}_{M} ( v ) P {\sum }_{l = 0}^{{R}_{L} - 1} D ( v , l ) {( {R}_{Q} )}^{l} = 0.085 \cdot P \cdot \\ ( 0.4706 + 6 \cdot 0.2588 + 36 \cdot 0.2706 ) \\ = 1.0000 \cdot P\end{matrix} \qquad ( 4 )$$

However, the various up-line distribution fractions can be modulated and the member-distribution parameter to change the relationship to “<” or “>”. If the top of the up-line receives more amplification, he/she might have an incentive to spend more to raise the IRS limit cap. Alternatively, too much amplification might be a disincentive because members 14 could make too little on their own purchases and feel their own purchasing endeavors only go to serve others. Further, certain combinations of distribution parameters resolve equation (3) with nonsensical values.

Note that equation (3) does not embody any ultimate distribution from the community pool mechanism, which complicates the choice of distribution percentages even further.

The distribution fractions used above were derived as follows, which serves as a trivial example of a derivation process.

First, assume equation (3) to hold true with equality. Second, a business decision is made to have members earn 4% on their own purchases for vendors whose member distribution fraction is 8.5%. The system's referral quota is 6 and referral length is 3. Thus:
D_{M}(v)=0.0850 (5)
D_{M}(v)·D(v,0)=0.0400 (6) [symbol]
D(v,0)=0.0400/0.0850=0.4706 (7)
R_{Q}=6 (8)
R_{L}=3 (9)
Applying (5) through (9) to equation (3) results in.:

$$D ( v , 0 ) + 6 \cdot D ( v , 1 ) + 36 \cdot D ( v , 2 ) = \frac{1}{{D}_{M} ( v )} \qquad ( 10 )$$

[symbol]

0.4706+6·D(v,1)+36·D(v,2)=11.7647 (11) [symbol]
6·D(v,1)+36·D(v,2)=11.2941 (12)
From equation (1):
D(v,1)+D(v,2)=1−0.4706=0.5294 (13)
Combining (12) and (13) and solving results in:
D(v,1)=0.2588 (14)
D(v,2)=0.2706 (15)

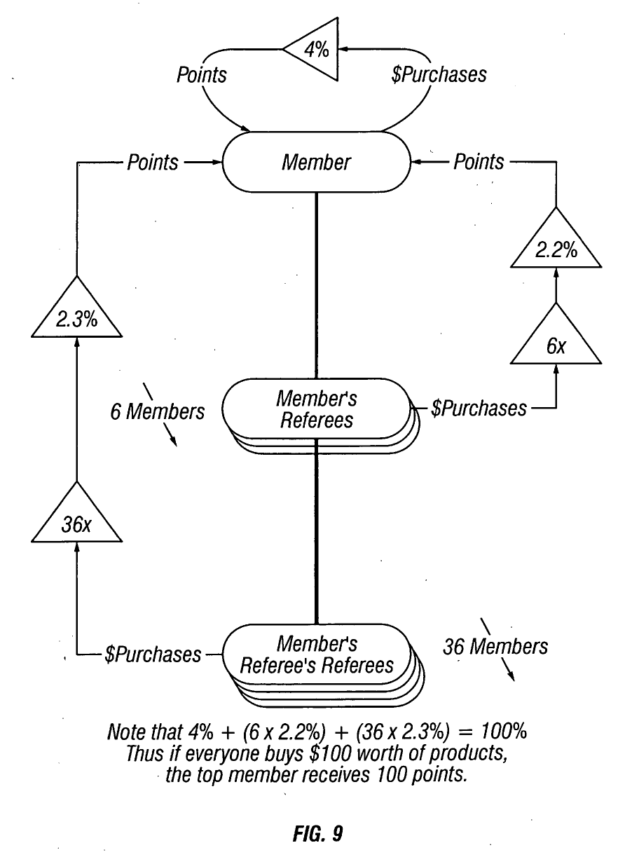

FIG. 9 illustrates the amplification effect connoted in equation (3) graphically with the referral quota equal to 6 and referral length equal to 3.%

### EXAMPLE 2

### Distribution Fractions

By way of illustration, and without limitation, this example discloses one embodiment of distribution fractions with tax and shipping costs being ignored. In this example, member m makes a purchase for p dollars from vendor v. The bank account of service provider system 10 (LBA) receives D_{LS}(v)·p dollars. The trust account of service provider system 10 (LTA) receives D_{M}(v)·p dollars to cover all of the points that will eventually be distributed to the up-line members. The trust account of service provider system 10 (LTA) receives D_{C}(v)·p dollars to cover the community pool point distribution.

Member m is awarded D_{M}(v)·D(v,0)·p points (after a time delay of T_{R}(v) from the transaction date on the bank transaction record.) Member M(m,1) is awarded D_{M}(v)·D(v,1)·p points (after a time delay of T_{R}(v) from the transaction date on the bank transaction record.) Member M(m,2) is awarded D_{M}(v)·D(v,2)·p points (after a time delay of T_{R}(v) from the transaction date on the bank transaction record.)

After a time delay of T_{C} from the previous community pool distribution, members C_{M}(m) ∀ m compete against a predetermined performance criterion, ostensibly those members within each community above the community average, and split the community pool distribution.

Members 14 and patrons may utilize their service provider system 10 credit/debit card for purchases at any entity that takes credit cards from issuing bank and its representative credit company. However, members 14 do not earn points beyond a fixed amount, by way of illustration and without limitation 1%, on their purchases unless they are purchasing products or services from an associated merchant 14. Service provider system 10 can include a database with commission/margin information on a per-vendor basis.

Vendors are typed as in-network or out-of-network. In network vendors are associated merchants 12. Members 14 earn points with associated merchants 12 only, except for points from service provider system 10 purchases, or in association with an associated financial institution. There are three possible states for vendors, (i) unknown (an out-of-network vendor), (ii) known in-network (associated merchant 12), and (iii) known out-of-network where the vendor has information in database 20 of service provider system 10 and was once an in-network vendor but is now treated as an unknown out-of-network vendor. Unknown vendors are placed in database 20 with “unknown” status. Although their name will not be present, future transactions will match the vendor code and allow for vendor statistics to be accrued.

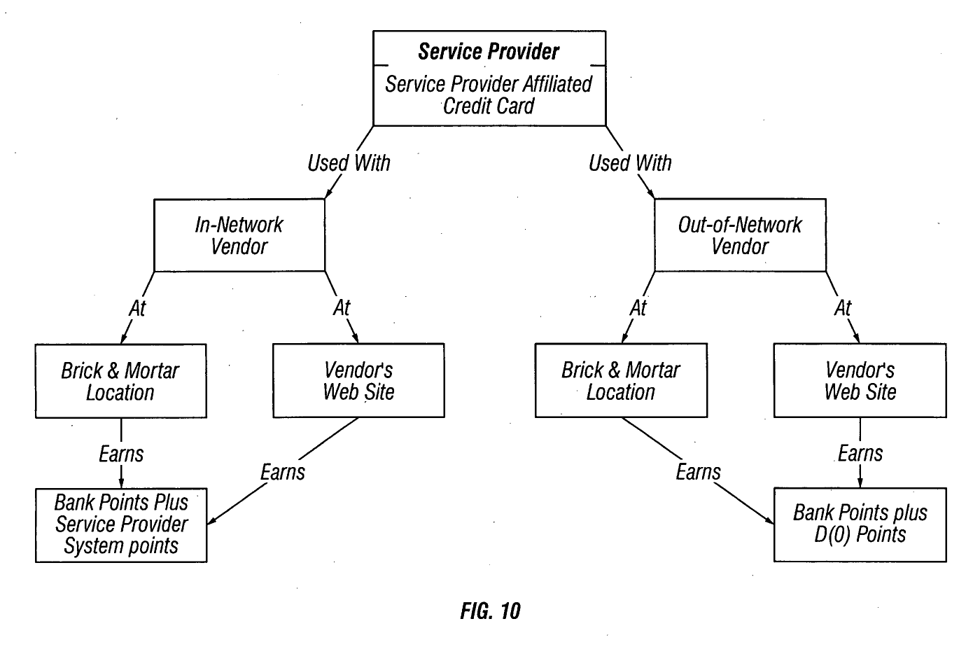

FIG. 10 illustrates how the status of the vendor effects point aggregation.

Members accrue points each time they purchase a product. In one embodiment, the points are not actually awarded to the member 14 for some number of days which can be configurable on a vendor basis in order to provide for product return. The product return period is the amount of time that passes before service provider system receives the bank transaction record for a particular purchase. By delaying the time of award, problematic, and potential criminal, exploitations of point awarding/redemption flows are mitigated. Several types of points are defined as follows:

TABLE 4
Point Types

| Point Type | Description |
|---|---|
| Earned Points | Points earned at the time a product is purchased. |
| Awarded Points | Earned points become awarded points after the |
| | product return period has elapsed. The awarded points |
| | are split among the up-line according to the |
| | mathematics discussed earlier. |
| | Awarded points are part of an equation indicating how |
| | many points a member has available for redemption. |
| | However, rather than converting awarded points to |
| | redeemed points, redeemed points are created to |
| | represent the amount redeemed by the member. |
| Redeemed | Points redeemed by a member for a service purchase. |
| Points | Kept by original award date. |
| Expired | Awarded points aged past a predetermined time limit |
| Points | (point lifetime). |
| Returned | Returned points are accrued whenever a member |
| Points | returns product and received a credit on the Service |
| | Provider System credit card. |

Earned points are attached to a member 14 at the time of product/service purchase and are converted to awarded points after the product return period has elapsed. Logic resources search point database 16, which can be once per day, to find, convert, and award points as described. The database schema and customer service interface accommodates this process. The up-line members 26 receiving awarded points are those in place at the time of the awarding process.

Except for earned to awarded point conversion, points are only created, they are never destroyed. However, some points may be thought of as negative points as they subtract from a member's 14 available cache for purchasing services or products. The concept of only creating monotonically increasing balances offers many mathematical and audit trail benefits.

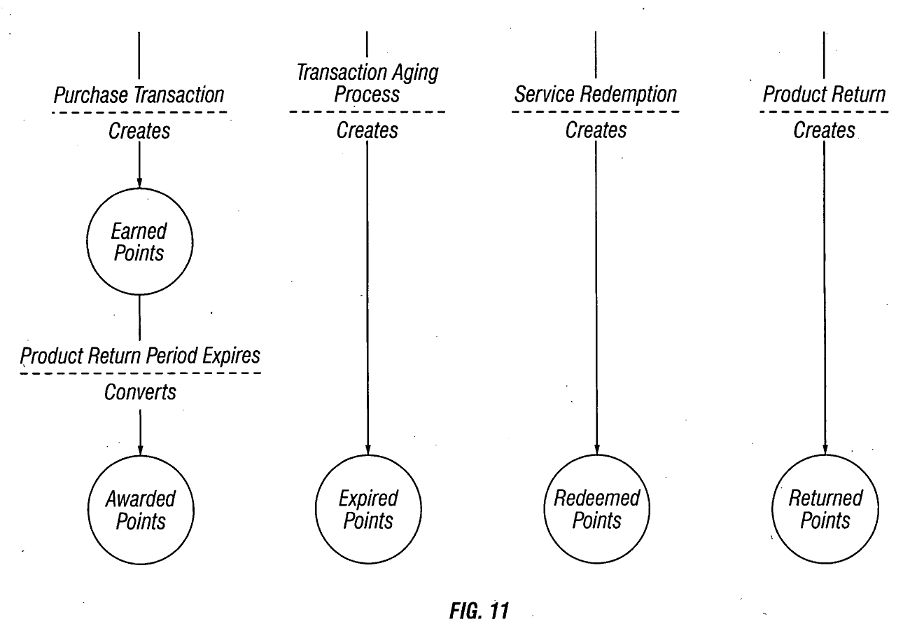

As illustrated in FIG. 11, point awarding is event driven by the processing of financial institution transaction records, that can be delivered electronically, by the financial institution associated with the credit/debit card associated through service provide system 10. Similarly, records in database 16 must be established each time a member 14 redeems points so that member activity 14 can be tracked and corrections made for extenuating circumstances (via the membership editor.)

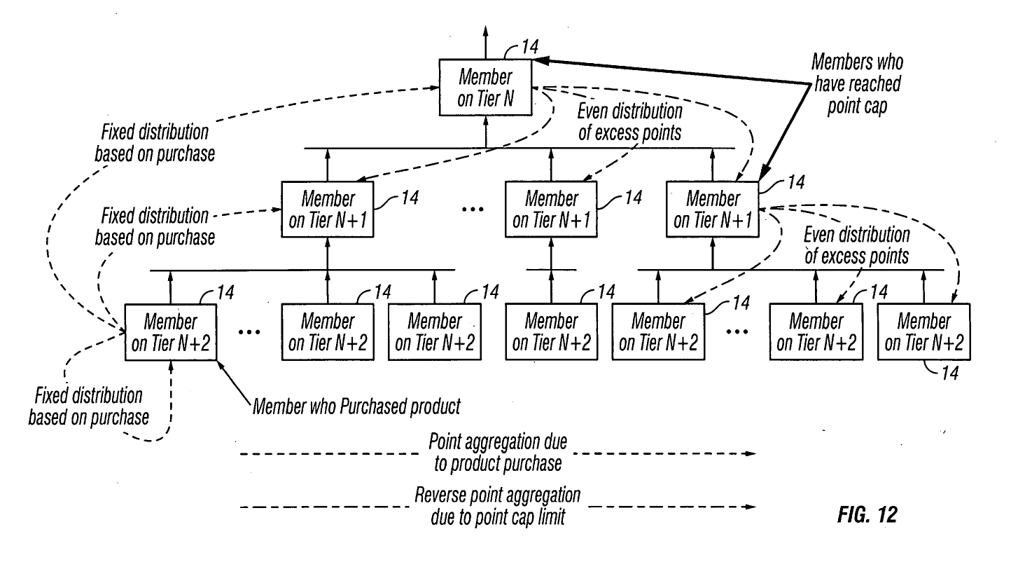

A system-wide mutable database parameter is the maximum number of points any one member 14 can accrue in a calendar year and is called the awardable point cap. In one embodiment, once a member's 14 awarded points total reaches the point cap limit, the excess points are distributed evenly to those members in his first level down-line 24. Should the distribution of those points exceed the same limit on one or more first level down-line members 24 then those excess points are handled recursively in exactly the same manner. However, should a second level member 14 reach the point cap, points are not distributed further. The number of levels is configurable and is equal to the down-line length. Instead, the amount of funds represented by the excess points are transferred from the trust account into the bank account of service provider system 10. FIG. 12 illustrates a typical distribution. The awardable point cap can be reset at the beginning of each calendar year.

In one embodiment, members may not redeem more points than the equivalent amount of money they have spent. The limit is referred to as the redeemable point cap. Consider the following timed scenario of a member's point state.

TABLE 5
Redeemable Point Cap Example

| | Points | | Points | Total $ |
|---|---|---|---|---|
| | Awarded | | Redeemed | Purchased |
| | Running | Points | Running | Running |
| Timed Action | Total | Current | Total | Total |
| Down-line | 1000.00 | 1000.00 | 0.00 | 0.00 |
| earns member | | | | |
| 1000 points. | | | | |
| Member | 1036.00 | 1036.00 | 0.00 | 900.00 |
| purchases | | | | |
| $900 worth of | | | | |
| products. | | | | |
| Member | 1036.00 | 536.00 | 500.00 | 900.00 |
| redeems 500 | | | | |
| points towards | | | | |
| an HSA. | | | | |

In one embodiment, there is a system-wide minimum point redemption, which by way of illustration, and without limitation, can be 250. The number of redeemable points the member above has (after the last line item):
Redeemable_points=min(points_current, total_$_purchased_running_total−points_redeemed_runningtotal−points_expired_runningtotal−points_returned_running_total)

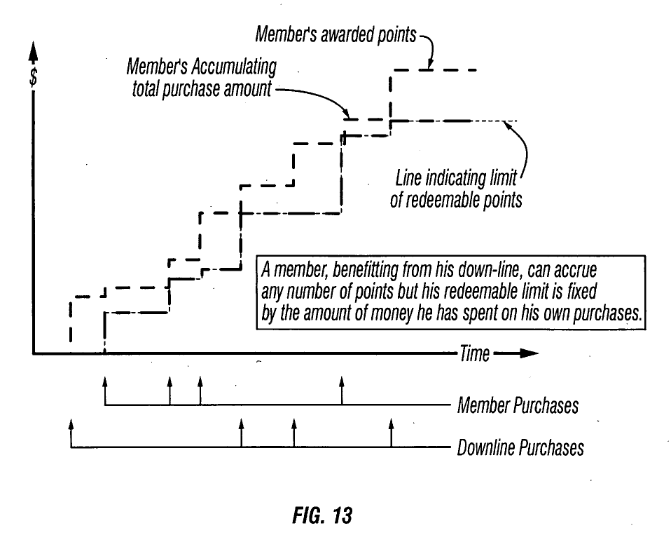

In this case, redeemable_points=min(536, 900−500—0−0)=400, which is above the system-wide minimum of 250 so the member has 400 additional points available for redemption. FIG. 13 illustrates one embodiment of a redeemable point cap.

Awarded points can have an infinite lifetime. Each time points are awarded to a member the date and number of points is recorded and associated with the member. The award date is not the date the earned points are converted to awarded points, but is the date the earned points were created (the purchase date.) The points maintain the dated grouping indefinitely.

One a regular basis, such as once per day, logic resources called the points awarding process can search database 16 for awarded points that have aged beyond the system-wide configurable and mutable lifetime data base parameter. The lifetime limit is called the point lifetime. In one embodiment, and in compliance with Internal Revenue Service requirements, the initial point lifetime can be 729 days. Awarded points older than the point lifetime create expired points.

When the point aging process expires a particular set of awarded points, a financial institution transaction occurs and funds representing the number of expired points are transferred from the trust account to the bank account of service provider system 10. Awarded points are not destroyed or converted. Instead, expired points are created to negate the efficacy of the awarded points, as shown in FIG. 14.

In one embodiment, points are converted to money at the rate of 1.00 points per $1.00. Points are kept to an accuracy of four decimal places internally and annunciated to two decimal places when displayed to members 14 and patrons.

In one embodiment, service provider system 10 profits by applying a sales commission on each sale. Commission percentages are contained in a database and are on a per-vendor basis. Service provider system 10 supports commission data entry and maintenance.

Members 14 can redeem previously awarded points to offset part or all of the cost of certain service purchases, as discussed above, which can be insurance and/or money transferal to a Health Savings Account. Awarded points may also be redeemed as credits to their credit/debit card to offset product purchases. When a member 14 redeems awarded points, redeemed points are created in association with the member's 14 transaction(s) having the oldest date.

Service provider system 10 can accommodate the fact different vendors have different return policies. In one embodiment, points are not awarded until the vendor-specific product return period expires. Product returns prior to the product return period expiration can result in a modification of the corresponding debit financial institution transaction record, which should have transaction earned status, to provide that the member 14 does not get the full, or any, point award corresponding to the original debit transaction. This can be accomplished by creating returned points. A financial institution credit transaction and the original debit transaction can be matched.

In one embodiment, if transaction matching cannot be accomplished the member's 14 returned point count can be adjusted by a factor corresponding to the financial institution credit amount. This can occur immediately upon receiving the financial institution transaction record rather than delaying for the product return period. The lack of delay can be used when a member 14 can redeem the awarded points and return the product, gaining a credit on his credit/debit card. In this instance the returned point adjustment can not be made against the actual awarded points but only against past or future point awards, and the member 14 can opt out of the service provider system 10 with an unbalanced reconciliation. A similar problem can arise if the vendor honors a product return past the product return period because the original debit transaction's point distribution is already awarded and may have been redeemed by the member 14. Another issue occurs when a member 14 makes a purchase, immediately returns the product, and the debit record from the financial institution is delayed by the product return period while the credit record is processed during the day's batch processing. This can result in a period of time where the member 14 would lose redemption access to some previous legitimately awarded points.

In one embodiment, service provider system 10 has a referral length of three Tier 1 members 14 have their up-line 26 length shortened since there is no real root member. Similarly, tier 2 members 14 also have a shortened up-line 26 length. The un-awardable points must go somewhere because money was received through the product sale. By convention, the “un-awardable points” are awarded to the root member who represents profits for service provider system 10. Service provider system 10 benefits by purchases made by the “tree top” members.

Round-off errors can occur anytime a multiply or divide occurs involving money or point parameters. Round-off errors can be handled using normally accepted accounting procedures and guidelines as proscribed by state and federal bureaucracies.

By way of illustration, and without limitation, a banker's rounding can be a number rounded to the nearest digit, and if it is half-way between two value then it is rounded to the nearest even digit, ensuring on average that rounding errors cancel out. For example, 12.345 is rounded to four digits is 12.34 and 12.355 rounded to four digits is 12.36. Decimal arithmetic libraries can be used; points and money values can be signed so deficit values can be maintained; database fields can be “big decimal” with at least 18 digits of total field and at least 4 digits of decimal fraction. If a calculation is done in the domain of money, and an equivalent number of points is to be calculated, a separate calculation with multiplies or divides need not be done to arrive at the point value. Instead, the money can be directly converted to points because since there is no round-off error in the conversion. Similarly, if the calculation is done in the point domain, a direct conversion to money can be done rather than doing an equivalent calculation in the money domain. A frequent pattern occurs where a calculation is done and rounded to the nearest integer value, as when dealing with points. The remaining pool of points can be calculated by subtraction whenever possible. For example:
Points_remaining=total_points−(28%*total_points)

Membership editor allows a system administrator with sufficient privilege to search, display, and modify various membership parameters and associations. In particular the membership editor can provide for searching membership ID, allows search on member's 14 phone number and email address; search on member's 14 name with a selection from a list of entry's having the same name, permits display of membership information; allows editing of membership information, provides for display of membership sub-tree through at least the down-line size sub-tree, allows the repositioning of a sub-tree to another member 14; and allow the commit/cancel of an editing session.

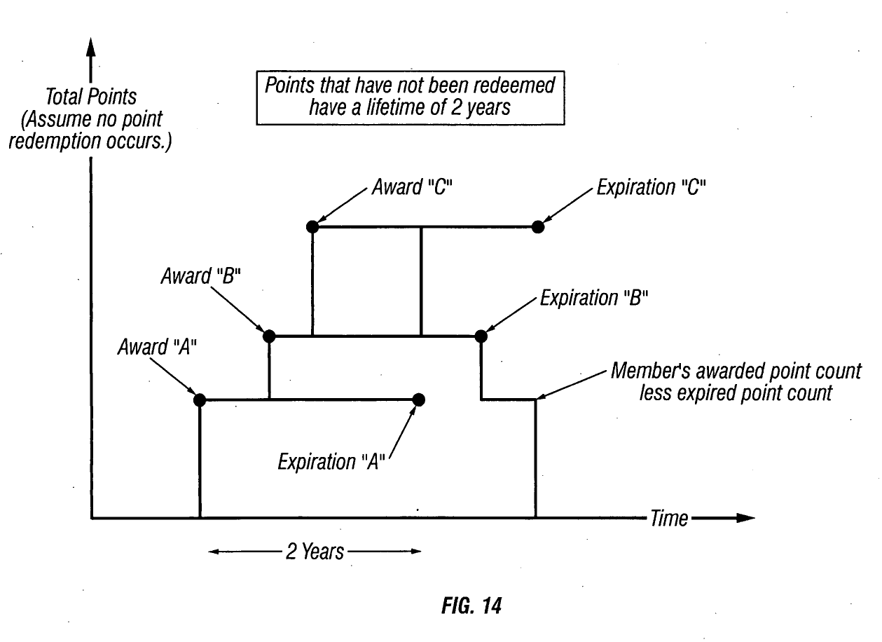

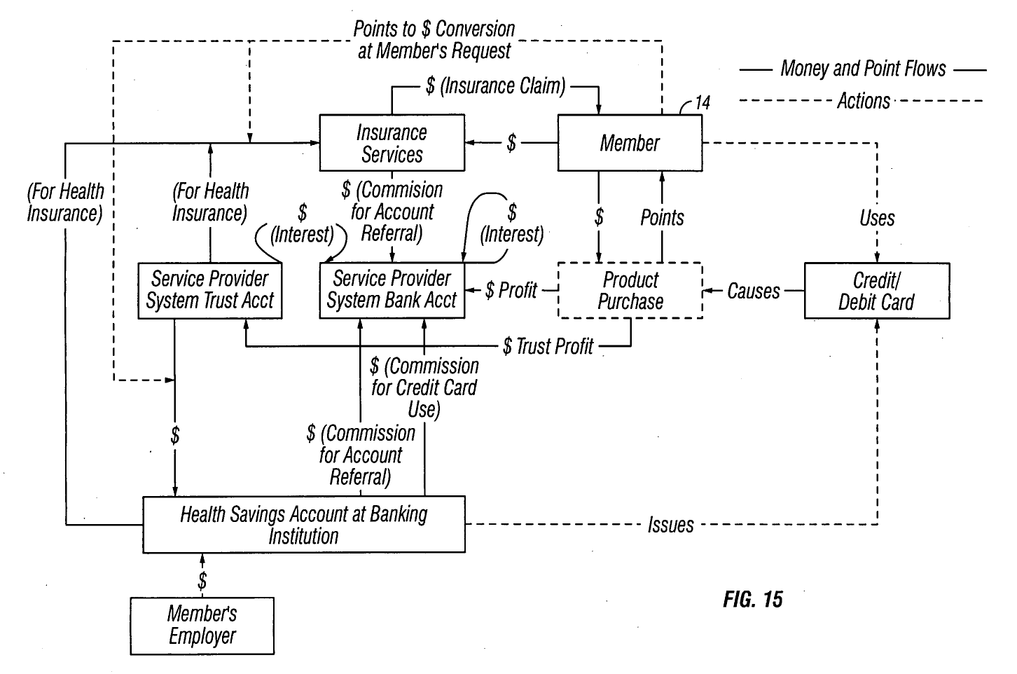

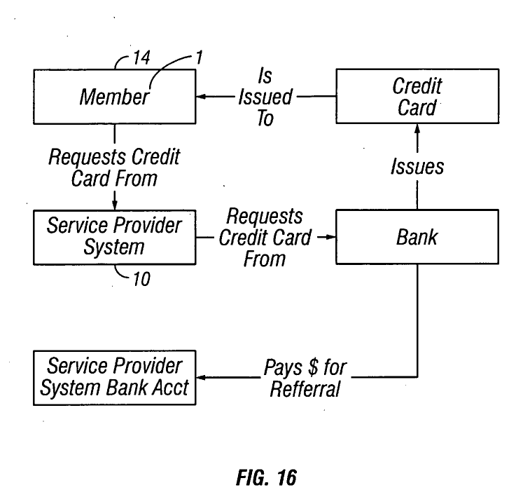

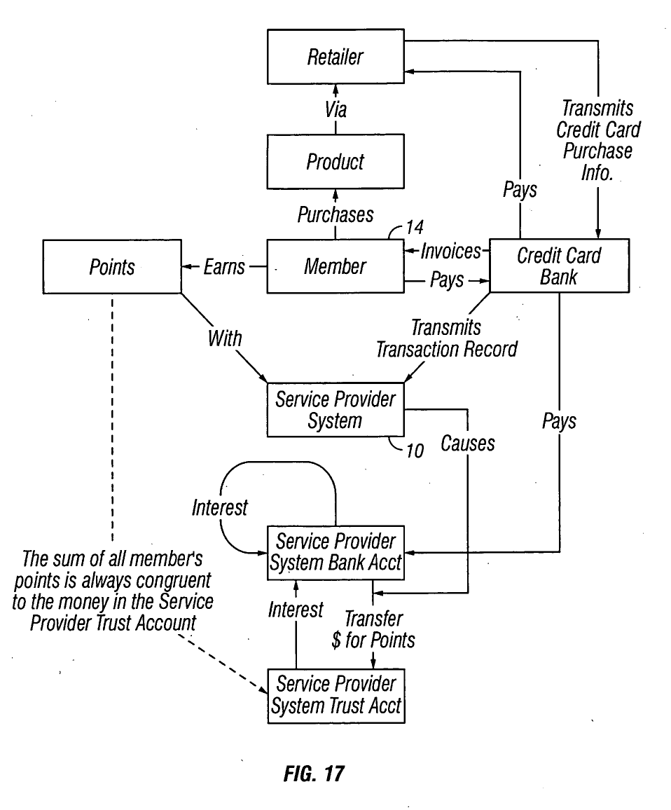

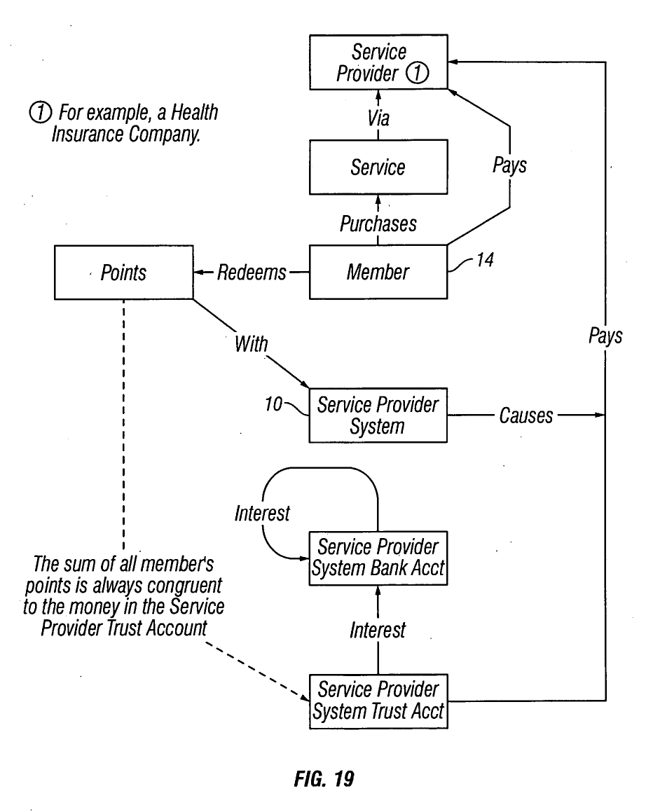

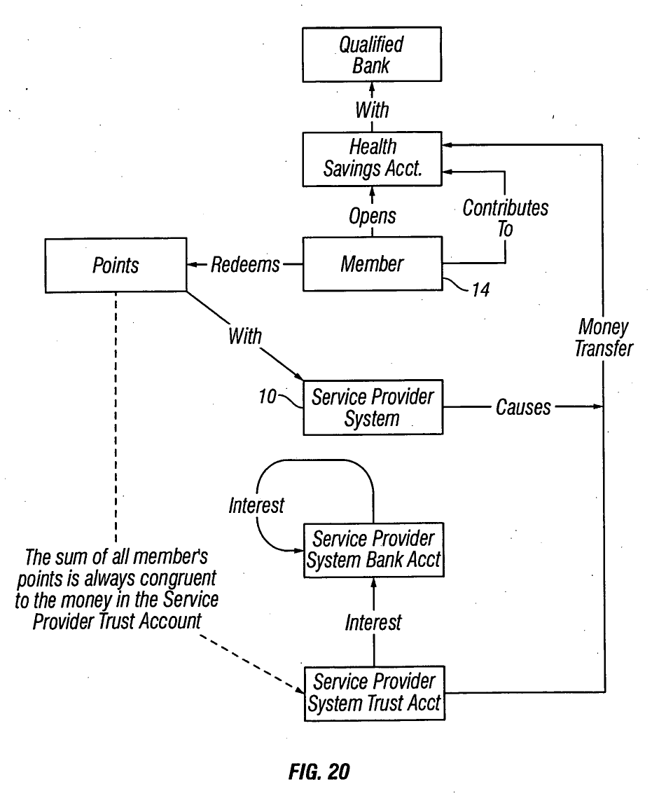

FIG. 15 illustrates one embodiment of the flow of consideration through service provider system 10. FIGS. 16 through 19 illustrated different flow, and relationships with service provider system 10.

In one embodiment, users are staff of service provider system 10 that login to service provider system 10, which can be by membership editor. The login has nothing to do with browsing the web pages of service provider system 10 that are visible to all visitors, but may have to do with web pages designed for operation and modification of service provider system 10. Users can have their maximum security level established in a database and may log in under various roles indicating security level up to and including their maximum allowed security level. Various functions and database tables of service provider system 10 can require a minimum specified security level to be modified. The security levels are as follows.

TABLE 6
User Security Levels

| Security Level | Description |
|---|---|
| Logged Out | No access to the system is allowed |
| Browser | Read-only access to many of the |
| | system's internal data stores. |
| Operator | Read access to most of the system's |
| | internal data stores. Write access to |
| | some of the internal data stores, such |
| | as membership personal details like |
| | name and address. |
| Supervisor | Read and write access to most all of |
| | the system's internal data stores |
| | except those that govern key system |
| | operation (like the up-line distribution |
| | percentages, etc.) |
| Marketing | Complete read access to all of the |
| | system's tables but no write access. |
| Administrator | Complete read and write access to all |
| | of the system's internal data stores |
| | except those that exist only to provide |
| | table-driven programming functionality. |
| Developer | Complete read and write access to all |
| | of the system's internal data stores. |

The total number of awarded points in the membership tree represents real funds allocated for membership purchase redemptions. Hence the total number of awarded points must always equal the balance of the trust account of service system 10.

$${\sum }_{{All}_{Members}} awarded\_points = LTA\_Balance ( \$ )$$

Depending upon when the consistency check is executed there can be an imbalance due to batch processing time-delays of financial institution transactions within service provider system 10, particularly the product return period. Interest is earned on the LTA resulting in an imbalance. Periodically, LTA interest is transferred to the LBA and should be coordinated with the LTA interest accrual schedule.

The membership tree 22 can be periodically traversed to assure all members 14 are properly positioned within the tree morphology. By way of illustration, and without limitation, membership tree 22 can be periodically traversed to provide that there are no orphaned sub-trees or members 14. Patrons are typically orphaned.

Logic resources are utilized to assure other member-associated data is consistent, such as being present and remaining within legal considerations. These can include, membership ID, credit card information, required personal information such as email, phone numbers, point and money values, and the like.

Several statistics are calculated and made available by service provider system 10 to evaluate business models. Reports can be refreshed at lease daily. Monthly reports can also be generated by service provider system. Reports can include the number of, members 14 of each type, new members of each type, patrons receiving earned points, earned points created, patrons receiving awarded points, awarded points created, patrons redeeming points, redeemed points created, top 100 members based upon earned points, points earned in a previous day/month, top 100 members based upon awarded points and the number of points awarded in a previous day/month, top 100 members based upon redeemed points and the number of points redeemed in previous day/month, sub-tree population percentage of entire membership tree total earned points within service provider system 10, total awarded points within service provider system 10, total redeemed points within service provider system 10, expired points, and the like.

Automated fraud detection mechanisms can be implemented within service provider system 10. By way of illustration, and without limitation, excessive product returns can be correlated to a particular product or individual. Daily and monthly reports can be used to detect obvious high volume users and manual inspection of those user's purchases may be necessary which can be by way of a data base query. In general, points are created and destroyed by money flows. If those flows have automated fraud detection mechanisms, the point engine can be covered commensurately. Careful inspection of point totals can be used during the first days and months of service provider system 10 operation to verify correct operation of the point engine.

The following is one embodiment of a database schema based upon the previous document sections.

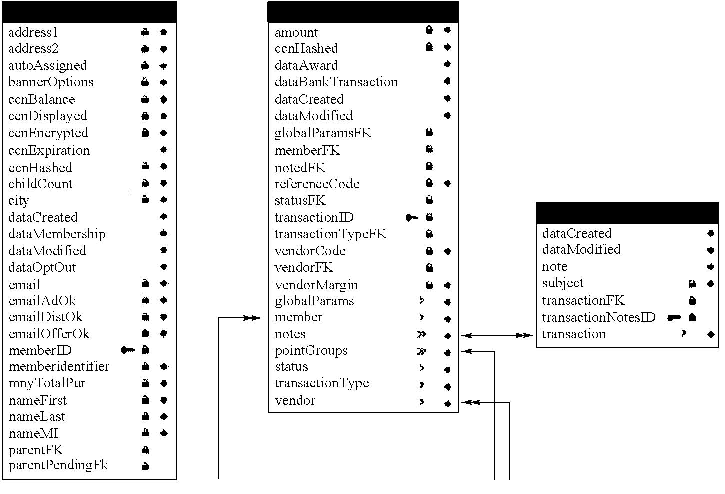

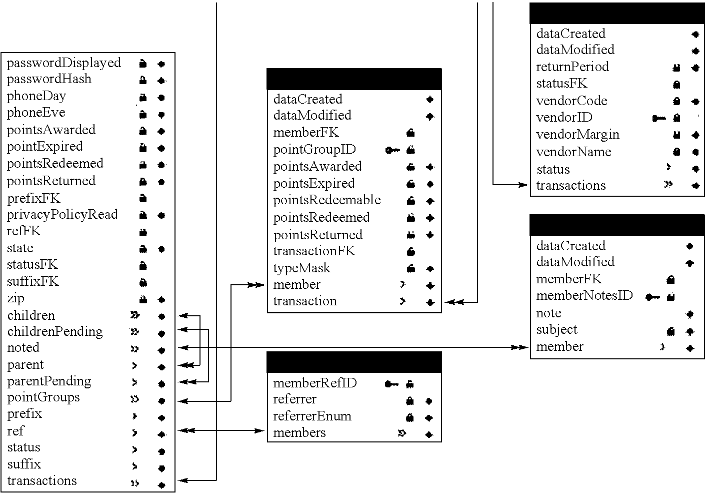

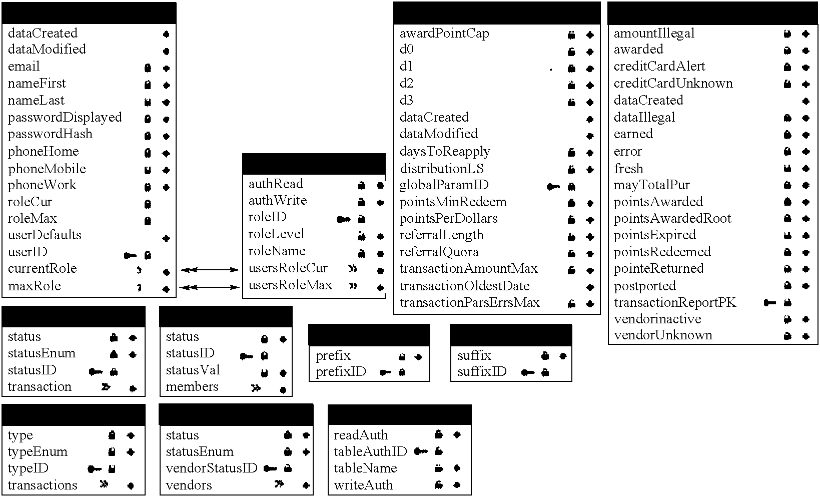

The foregoing description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

1. A method of purchasing products and services, comprising:
providing a service provider system, the service provider system offering products for sale through the service provider system directly and also through associated merchants that are authorized to be associated with the service provider system;
enrolling members in the service provider system;
awarding points to members for purchases of products through the service provider system and the associated merchants; and
wherein points utilized by members, through the service provider system or associated merchants, are tax free for federal income tax purposes when the points are applied for, (i) health related products and services, (ii) payment of health insurance premiums, (iii) deposit into a Health Savings Account or a similarly approved account, and (iv) purchase of a health care plan.

2. The method of claim 1, wherein the points are rebate points that are directly related and limited by the amount of purchases made by a member awarded the points.

3. The method of claim 1, wherein points awarded by the service provider system and associated merchants are used as an offset against the purchase price of future products and services purchased by the member originally awarded the points.

4. The method of claim 1, wherein the points are used for purchase price adjustments through the service provider or associated merchants.

5. The method of claim 1, wherein the points are rebates that are tied to the purchase of goods or services.

6. The method of claim 1, wherein the points represent an adjustment to purchase price rather than as gross income under Section 61 of the Internal Revenue Code.

7. The method of claim 2, wherein the service provider system is not required to make information reporting under section 6041A of the Internal Revenue Code for awarding the points.

8. A method of purchasing products and services, comprising:
providing a service provider system, the service provider system offering products for sale through the service provider system directly and also through associated merchants that are authorized to be associated with the service provider system;
enrolling members in the service provider system;
awarding points to a member for purchases made through the service provider system or associated merchants that are, (i) made by the member itself, (ii) made by members who were referred to the service provider system by the member, and (iii) made by members who were referred to the service provider system by members in (ii), wherein members in (i), (ii) and (iii) are collectively a member's community; and
wherein points utilized by members, through the service provider system or associated merchants, are tax free for federal income tax purposes when the points are applied for, (i) health related products or services, (ii) payment of health insurance premiums, (iii) deposit into a Health Savings Account or a similarly approved account, and (iv) purchase of a health care plan.

9. The method of claim 8, wherein the number of points that a member can apply to pay for, (i) health related products and services, (ii) health insurance premiums, (iii) deposit into a Health Savings Account or a similarly approved account, and (iv) purchase of a health plan, has an annual cap.

10. The method of claim 8, wherein an annual amount of points awarded to an individual member that are non-taxable for federal income tax purposes is limited to an annual amount of actual purchases made by the individual member through the service provider system or associated merchants.

11. The method of claim 8, wherein the points are rebate points that are directly related and limited by the amount of purchases made by a member awarded the points.

12. The method of claim 8, wherein points awarded by the service provider system and associated merchants are used as an offset against the purchase price of future products and services purchased by the member originally awarded the points.

13. The method of claim 8, wherein the points are used for purchase price adjustments through the service provider or associated merchants.

14. The method of claim 8, wherein the points are rebates that are tied to the purchase of goods or services.

15. The method of claim 8, wherein the points represent an adjustment to purchase price rather than as gross income under Section 61 of the Internal Revenue Code.

16. The method of claim 8, wherein the service provider system is not required to make information reporting under section 6041A of the Internal Revenue Code for awarding the points.

17. The method of claim 8, further comprising:
notifying members of their point balances.

18. The method of claim 8, further comprising:
notifying members of a number of points needed by the member to purchase products and services.

19. The method of claim 8, further comprising:
recording within a computer memory the points awarded to members.

20. The method of claim 8, wherein at least a portion of the points are utilized by members for future purchases of products or services through the service provider system or an associated merchant.

21. The method of claim 8, further comprising:
aggregating the purchasing power of the members in the service provider system.

22. The method of claim 8, wherein at least a portion of the points can not be converted to cash or a cash equivalent if they are utilized outside the service provider system.

23. The method of claim 8, wherein none of the points can be converted to cash or a cash equivalent if they are utilized outside the service provider system.

26. The method of claim 8, wherein points that are non-taxable for federal income tax purposes have a limited life.

27. The method of claim 8, wherein points that are non-taxable for federal income tax purposes have a life of no more than 24 months.

28. The method of claim 8, wherein points not used by a member remain within the service provider system.

29. The method of claim 8, wherein the service provider system includes a browsable catalog of products and services.

30. The method of claim 8, wherein at least a portion of the associated merchants have browsable catalogs of products and services.

31. A method of purchasing products and services, comprising:
providing a service provider system, the service provider system offering products for sale through the service provider system directly and also through associated merchants that are authorized to be associated with the service provider system;
enrolling members in the service provider system;
awarding points to a member for purchases made through the service provider system or associated merchants that are, (i) made by the member itself, (ii) made by members who were referred to the service provider system by the member, and (iii) made by members who were referred to the service provider system by members in (ii), wherein members in (i), (ii) and (iii) are collectively a member's community; and
wherein points utilized by members, through the service provider system or associated merchants, are tax free for federal income tax purposes when the points are applied for, (i) health related products or services, (ii) payment of health insurance premiums, (iii) deposit into a Health Savings Account or a similarly approved account, and (iv) purchase of a health care plan.

32. The method of claim 31, wherein points are rebate points that are directly related and limited by the amount of purchases made by a member awarded the points.

33. The method of claim 31, wherein points awarded by the service provider system and associated merchants are used as an offset against the purchase price of future products and services purchased by the member originally awarded the points.

34. The method of claim 31, wherein the points are used for purchase price adjustments through the service provider or associated merchants.

35. The method of claim 31, wherein the points are rebates that are tied to the purchase of goods or services.

36. The method of claim 31, wherein the points represent an adjustment to purchase price rather than as gross income under Section 61 of the Internal Revenue Code.

37. The method of claim 31, wherein the number of points that a member can apply to pay for, (i) health related products and services, (ii) health insurance premiums, (iii) deposit into a Health Savings Account or a similarly approved account, and (iv) purchase of a health plan, has an annual cap.

38. The method of claim 31, wherein an annual amount of points awarded to an individual member that are non-taxable for federal income tax purposes is limited to an annual amount of actual purchases made by the individual member through the service provider system or associated merchants.

39. The method of claim 31, further comprising:
notifying members of their point balances.

40. The method of claim 31, further comprising:
notifying members of a number of points needed by the member to purchase products and services.

41. The method of claim 31, further comprising:
recording within a computer memory the points awarded to members.

42. The method of claim 31, wherein at least a portion of the points are utilized by members for future purchases of products or services through the service provider system or an associated merchant.

43. The method of claim 31, further comprising:
aggregating the purchasing power of the members in the service provider system.

44. The method of claim 31, wherein at least a portion of the points can not be converted to cash or a cash equivalent if they are utilized outside the service provider system.

45. The method of claim 31, wherein none of the points can be converted to cash or a cash equivalent if they are utilized outside the service provider system.

46. The method of claim 31, wherein points that are non-taxable for federal income tax purposes have a limited life.

47. The method of claim 31, wherein points that are non-taxable for federal income tax purposes have a life of no more than 24 months.

48. The method of claim 31, wherein points not used by a member remain within the service provider system.

49. The method of claim 31, wherein the service provider system includes a browsable catalog of products and services.

50. The method of claim 31, wherein at least a portion of the associated merchants have browsable catalogs of products and services.

51. The method of claim 37, wherein points that exceed a member's cap are distributed to it's member community.

52. The method of claim 37, wherein points that exceed a member's cap are distributed equally to it's member community.

53. A method of purchasing products and services, comprising:
providing a service provider system, the service provider system offering products for sale through the service provider system directly and also through associated merchants that are authorized to be associated with the service provider system;
enrolling members in the service provider system;
providing members with service provider debit or credit cards;
awarding points to a member for purchases made through the service provider system or associated merchants that are, (i) made by the member itself, (ii) made by members who were referred to the service provider system by the member, and (iii) made by members who were referred to the service provider system by members in (ii), wherein members in (i), (ii) and (iii) are collectively a member's community; and
wherein points utilized by members, through the service provider system or associated merchants, are tax free for federal income tax purposes when the points are applied for, (i) health related products or services, (ii) payment of health insurance premiums, (iii) deposit into a Health Savings Account or a similarly approved account, and (iv) purchase of a health care plan.

54. The method of claim 53, wherein points are rebate points that are directly related and limited by the amount of purchases made by a member awarded the points.

55. The method of claim 53, wherein points awarded by the service provider system and associated merchants are used as an offset against the purchase price of future products and services purchased by the member originally awarded the points.

56. The method of claim 53, wherein the points are used for purchase price adjustments through the service provider or associated merchants.

57. The method of claim 53, wherein the points are rebates that are tied to the purchase of goods or services.

58. The method of claim 53, wherein the points represent an adjustment to purchase price rather than as gross income under Section 61 of the Internal Revenue. Code.

59. The method of claim 53, wherein the number of points that a member can apply to pay for, (i) health related products and services, (ii) health insurance premiums, (iii) deposit into a Health Savings Account or a similarly approved account, and (iv) purchase of a health plan, has an annual cap.

60. The method of claim 53, wherein an annual amount of points awarded to an individual member that are non-taxable for federal income tax purposes is limited to an annual amount of actual purchases made by the individual member through the service provider system or associated merchants.

61. The method of claim 53, further comprising:
notifying members of their point balances.

62. The method of claim 53, further comprising:
notifying members of a number of points needed by the member to purchase products and services.

63. The method of claim 53, further comprising:
recording within a computer memory the points awarded to members.

64. The method of claim 53, wherein at least a portion of the points are utilized by members for future purchases of products or services through the service provider system or an associated merchant.

65. The method of claim 53, further comprising:
aggregating the purchasing power of the members in the service provider system.

66. The method of claim 53, wherein at least a portion of the points can not be converted to cash or a cash equivalent if they are utilized outside the service provider system.

67. The method of claim 53, wherein none of the points can be converted to cash or a cash equivalent if they are utilized outside the service provider system.

68. The method of claim 53, wherein points that are non-taxable for federal income tax purposes have a limited life.

69. The method of claim 53, wherein points that are non-taxable for federal income tax purposes have a life of no more than 24 months.

70. The method of claim 53, wherein points not used by a member remain within the service provider system.

71. The method of claim 53, wherein the service provider system includes a browsable catalog of products and services.

72. The method of claim 53, wherein at least a portion of the associated merchants have browsable catalogs of products and services.

73. The method of claim 59, wherein points that exceed a member's cap are distributed to it's member community.

74. The method of claim 59, wherein points that exceed a member's cap are distributed equally to it's member community.

75. The method of claim 53, wherein the service provider debit or credit card is backed by a financial institution associated the service provider community.

76. The method of claim 53, wherein the service provider debit or credit card has an annual fee.

77. The method of claim 76, wherein at least a portion of the points can be utilized for payment of the annual fee.

78. The method of claim 53, wherein the service provider debit or credit is issued by a credit card financial institution associated with the service provider system.

79. The method of claim 53, wherein the service provider system receives a portion of a debit or credit card fee associated with using the debit or credit card.

80. A method of purchasing products and services, comprising:
providing a service provider system, the service provider system offering products for sale through the service provider system directly and also through associated merchants that are authorized to be associated with the service provider system;
enrolling members in the service provider system;
awarding points to a member for purchases made through the service provider system or associated merchants that are, (i) made by the member itself, (ii) made by members who were referred to the service provider system by the member, and (iii) made by members who were referred to the service provider system by members in (ii), wherein members in (i), (ii) and (iii) are collectively a member's community; and
wherein the points represent an adjustment to purchase price rather than as gross income under Section 61 of the Internal Revenue Code.

81. The method of claim 80, wherein the points are non-taxable for federal income tax purposes.

82. The method of claim 80, wherein points are rebate points that are directly related and limited by the amount of purchases made by a member awarded the points.

84. The method of claim 80, wherein points awarded by the service provider system and associated merchants are used as an offset against the purchase price of future products and services purchased by the member originally awarded the points.

85. The method of claim 80, wherein the points are used for purchase price adjustments through the service provider or associated merchants.

86. The method of claim 80, wherein the points are rebates that are tied to the purchase of goods or services.

87. The method of claim 80, wherein an annual amount of points awarded to an individual member that are non-taxable for federal income tax purposes has an annual cap.

88. The method of claim 80, wherein an annual amount of points awarded to an individual member that are non-taxable for federal income tax purposes is limited to an annual amount of actual purchases made by the individual member through the service provider system or associated merchants.

89. The method of claim 80, further comprising:
notifying members of their point balances.

90. The method of claim 80, further comprising:
notifying members of a number of points needed by the member to purchase products and services.

91. The method of claim 80, further comprising:
recording within a computer memory the points awarded to members.

92. The method of claim 80, wherein at least a portion of the points are utilized by members for future purchases of products or services through the service provider system or an associated merchant.

93. The method of claim 80, further comprising:
aggregating the purchasing power of the members in the service provider system.

94. The method of claim 80, wherein at least a portion of the points can not be converted to cash or a cash equivalent if they are utilized outside the service provider system.

95. The method of claim 80, wherein none of the points can be converted to cash or a cash equivalent if they are utilized outside the service provider system.

96. The method of claim 80, the points have a limited life.

97. The method of claim 80, wherein the points have a life of no more than 24 months.

98. The method of claim 80, wherein points not used by a member remain within the service provider system.

99. The method of claim 80, wherein the service provider system includes a browsable catalog of products and services.

100. The method of claim 80, wherein at least a portion of the associated merchants have browsable catalogs of products and services.

101. The method of claim 80, wherein points that exceed a member's cap are distributed to it's member community.

102. The method of claim 80, wherein points that exceed a member's cap are distributed equally to it's member community.

103. A method of purchasing products and services, comprising:
providing a service provider system, the service provider system offering products for sale through the service provider system directly and also through associated merchants that are authorized to be associated with the service provider system;
enrolling members in the service provider system;
awarding points to a member for purchases made through the service provider system or associated merchants that are, (i) made by the member itself, (ii) made by members who were referred to the service provider system by the member, and (iii) made by members who were referred to the service provider system by members in (ii), wherein members in (i), (ii) and (iii) are collectively a member's community; and
wherein the points are rebate points that are directly related and limited by the amount of purchases made by a member awarded the points.

104. A method of purchasing products and services, comprising:
providing a service provider system, the service provider system offering products for sale through the service provider system directly and also through associated merchants that are authorized to be associated with the service provider system;
enrolling members in the service provider system;
awarding points to a member for purchases made through the service provider system or associated merchants that are, (i) made by the member itself, (ii) made by members who were referred to the service provider system by the member, and (iii) made by members who were referred to the service provider system by members in (ii), wherein members in (i), (ii) and (iii) are collectively a member's community; and
wherein points awarded by the service provider system and associated merchants are used as an offset against the purchase price of future products and services purchased by the member originally awarded the points.

105. A method of purchasing products and services, comprising:
providing a service provider system, the service provider system offering products for sale through the service provider system directly and also through associated merchants that are authorized to be associated with the service provider system;
enrolling members in the service provider system;
awarding points to a member for purchases made through the service provider system or associated merchants that are, (i) made by the member itself, (ii) made by members who were referred to the service provider system by the member, and (iii) made by members who were referred to the service provider system by members in (ii), wherein members in (i), (ii) and (iii) are collectively a member's community; and
wherein the points are used for purchase price adjustments through the service provider or associated merchants.

106. A method of purchasing products and services, comprising:
providing a service provider system, the service provider system offering products for sale through the service provider system directly and also through associated merchants that are authorized to be associated with the service provider system;
enrolling members in the service provider system;
awarding points to a member for purchases made through the service provider system or associated merchants that are, (i) made by the member itself, (ii) made by members who were referred to the service provider system by the member, and (iii) made by members who were referred to the service provider system by members in (ii), wherein members in (i), (ii) and (iii) are collectively a member's community; and
wherein the service provider system is not required to make information reporting under section 6041A of the Internal Revenue Code for awarding the points.

107. A method of purchasing products and services, comprising:
providing a service provider system, the service provider system offering products for sale through the service provider system directly and also through associated merchants that are authorized to be associated with the service provider system;
enrolling members in the service provider system;
awarding points to a member for purchases made through the service provider system and associated merchants that are, (i) made by the member itself, (ii) made by members who were referred to the service provider system by the member, and (iii) made by members who were referred to the service provider system by members in (ii), wherein members in (i), (ii) and (iii) are collectively a member's community;
awarding points to members for purchases made with a credit card issued by a merchant, irrespective if the merchant is an associated merchant, that are, (i) made by the member itself, (ii) made by members who were referred to the service provider system by the member, and (iii) made by members who were referred to the service provider system by members in (ii); and
wherein points awarded by the service provider system and associated merchants are used as an offset against the purchase price of future products and services purchased through the service provider system or an associated merchant.

108. A method of purchasing products and services, comprising:
providing a service provider system, the service provider system offering products for sale through the service provider system directly and also through associated merchants that are authorized to be associated with the service provider system;
enrolling members in the service provider system;
awarding points to a member for purchases made through the service provider system or associated merchants that are, (i) made by the member itself, (ii) made by members who were referred to the service provider system by the member, and (iii) made by members who were referred to the service provider system by members in (ii), wherein members in (i), (ii) and (iii) are collectively a member's community;
awarding points to members for purchases made with a credit card issued by a merchant, irrespective if the merchant is an associated merchant, that are, (i) made by the member itself, (ii) made by members who were referred to the service provider system by the member, and (iii) made by members who were referred to the service provider system by members in (ii); and
wherein the points are used for purchase price adjustments through the service provider or associated merchants.

109. A method of purchasing products and services, comprising:
providing a service provider system, the service provider system offering products for sale through the service provider system directly and also through associated merchants that are authorized to be associated with the service provider system;
enrolling members in the service provider system;
awarding points to a member for purchases made through the service provider system or associated merchants that are, (i) made by the member itself, (ii) made by members who were referred to the service provider system by the member, and (iii) made by members who were referred to the service provider system by members in (ii), wherein members in (i), (ii) and (iii) are collectively a member's community;
awarding points to members for purchases made with a credit card issued by a merchant, irrespective if the merchant is an associated merchant, that are, (i) made by the member itself, (ii) made by members who were referred to the service provider system by the member, and (iii) made by members who were referred to the service provider system by members in (ii); and
wherein the points are rebate points that are directly related and limited by the amount of purchases made by a member awarded the points.

110. A method of purchasing products and services, comprising:
providing a service provider system, the service provider system offering products for sale through the service provider system directly and also through associated merchants that are authorized to be associated with the service provider system;
enrolling members in the service provider system;
awarding points to a member for purchases made through the service provider system or associated merchants that are, (i) made by the member itself, (ii) made by members who were referred to the service provider system by the member, and (iii) made by members who were referred to the service provider system by members in (ii), wherein members in (i), (ii) and (iii) are collectively a member's community;
awarding points to members for purchases made with a credit card issued by a merchant, irrespective if the merchant is an associated merchant, that are, (i) made by the member itself, (ii) made by members who were referred to the service provider system by the member, and (iii) made by members who were referred to the service provider system by members in (ii); and
wherein the service provider pays to the federal government any federal income tax due that results from awarding the points.

111. A method of purchasing products and services, comprising:
providing a service provider system, the service provider system offering products for sale through the service provider system directly and also through associated merchants that are authorized to be associated with the service provider system;
enrolling members in the service provider system;
awarding points to a member for purchases made through the service provider system or associated merchants that are, (i) made by the member itself, (ii) made by members who were referred to the service provider system by the member, and (iii) made by members who were referred to the service provider system by members in (ii), wherein members in (i), (ii) and (iii) are collectively a member's community; and
wherein the service provider pays to the federal government any federal income tax due that results from awarding the points.
